(19) United States
(12) Patent Application Publication
(10) Pub. No.: US 2025/0383215 A1
(43) Pub. Date: Dec. 18, 2025

(54) GEOMETRIC-BASED MANAGEMENT OF CONCURRENT MAP UPDATES FOR AUTONOMOUS SYSTEMS AND APPLICATIONS

(71) Applicant: NVIDIA Corporation, Santa Clara, CA (US)

(72) Inventor: Galen Collins, Seattle, WA (US)

(21) Appl. No.: 18/742,775

(22) Filed: Jun. 13, 2024

(51) Int. Cl. G01C 21/00; B60W 60/00

(52) U.S. Cl. CPC G01C 21/3807; B60W 60/001; G01C 21/3841; G01C 21/3896

(57) ABSTRACT

In various examples, causal ordering of concurrent updates for map resources may be enforced using geometric-based locks such that disparate systems may update the map resources concurrently. For instance, the disclosed systems and methods may lock first map resources corresponding to a first area of an environment so a first client may exclusively update the first map resources. While the first map resources are locked for updating by the first client, a request may be received from a second client to update second map resources. In some instances, the second map resources may correspond to a second area that overlaps the first area, and a timeout period—which may be extended by the first client—may be established. If the timeout period is met, the first map resources may be unlocked and the second client may resubmit the request to lock the second map resources for exclusive updating.

### BACKGROUND

For an autonomous or semi-autonomous vehicle or machine to safely navigate through an environment, the vehicle may rely on maps—such as navigational, standard definition (SD), and/or high-definition (HD) maps—corresponding to an environment in which the vehicle intends to operate. With respect to at least HD maps, and due to their detailed, three-dimensional, and high precision nature, these maps have proven effective for safe navigation of environments where map information is available. In some circumstances, an environment associated with a map may change, such as by changing locations of objects or features (e.g., roads, lanes, traffic signals, traffic signs, parking spots, construction, static barriers or objects, and/or any other features associated with the environment), and/or because updated or new types of data (e.g., LIDAR, RADAR, etc., when the original map relied on image data alone) become available. In such circumstances, it may be important for the map to be updated in order to reflect the changes to the environment.

However, because some maps may cover such large areas—in some cases, an entire country or continent, or the entire world—constant updating is required to maintain the precision of these maps as environments change and new data is generated. Since it is generally not feasible to perform all these updates manually, mapping systems may rely on fleets of distributed, automated systems to produce new content and make automatic updates to the maps. These automated systems may operate in parallel, in some cases, and update large sections of the maps concurrently as new data becomes available. However, issues may arise when a number of operations attempt to update the same sections of a map at the same time. For instance, simultaneous but separate updates may result in a completely corrupted map state, which could lead to any number of adverse events, including driving disconnects, driving errors, passenger discomfort or unease, and/or any other adverse events.

### SUMMARY

Embodiments of the present disclosure relate to geometric-based management of concurrent map updates for autonomous and semi-autonomous systems and applications. For instance, systems and methods described herein may use geometric-based, mutual exclusion locks to enforce causal ordering for concurrent updates to map resources such that disparate systems may update the map resources concurrently. For instance, the disclosed systems and methods may lock first map resources corresponding to a first area of an environment so a first client may exclusively update the first map resources. In some instances, a description of a geometric region corresponding to the first area of the environment may be associated with the lock. While the first map resources are locked for updating by the first client, a request may be received from a second client to update second map resources. In some instances, the second map resources may correspond to a second area that overlaps the first area as defined by the description of the geometric region. In such instances, an extendable timeout period may be established for the lock of the first map resources to ensure the first map resources do not become stale or deadlocked. If the timeout period is met or exceeded, the first map resources may be unlocked and the second client may resubmit the request to lock the second map resources for exclusive updating.

In contrast to conventional systems, the systems of the present disclosure, in some embodiments, are able to automatically enforce causal ordering of concurrent operations related to a geographic resource. For instance, by associating geometric region descriptions with active and/or requested locks for shared map resources, the systems of the present disclosure are able to automatically enforce causal ordering of hundreds—or even thousands—of concurrent updates to map resources without requiring manual scheduling or intervention. Additionally, in contrast to the conventional systems, the systems of the present disclosure, in some embodiments, ensure that operations (e.g., updates) make progress over time so that the shared map resources may continue to be updated as environmental changes take place. As such, and as described in more detail herein, by automatically enforcing causal ordering of concurrent operations and ensuring that the operations continue to make progress, the systems of the present disclosure are able to reduce the number of adverse events that are contributable to map resource corruption. This provides improvements over the conventional systems that may either require manual scheduling of map updates or may not enforce causal ordering at all. As such, the systems of the present disclosure may be less likely to provide machines (e.g., autonomous or semi-autonomous machines) with corrupted mapping information for use by the machines to traverse an environment.

### BRIEF DESCRIPTION OF THE DRAWINGS

The present systems and methods for geometric-based management of concurrent map updates for autonomous and semi-autonomous systems and applications are described in detail below with reference to the attached drawing figures, wherein:

FIG. 1 is a data flow diagram illustrating an example of a process for managing concurrent map updates, in accordance with some embodiments of the present disclosure;

FIG. 2 illustrates an example of scaling various aspects of a system, in accordance with some embodiments of the present disclosure;

FIG. 3A illustrates an example map of an environment, in accordance with some embodiments of the present disclosure;

FIG. 3B illustrates an example of portioning a map into multiple tiles, in accordance with some embodiments of the present disclosure;

FIGS. 4A and 4B illustrate an example comparison of resultant states of map tiles responsive to updates performed in a random order and updates performed according to an enforced, causal ordering, in accordance with some embodiments of the present disclosure;

FIGS. 5A and 5B illustrate another example comparison of resultant states of map tiles responsive to updates performed in a random order and updates performed according to an enforced, causal ordering, in accordance with some embodiments of the present disclosure;

FIG. 6 is a flow diagram illustrating an example method for managing locks for exclusive access to shared resources, in accordance with some embodiments of the present disclosure;

FIG. 7 is a flow diagram illustrating an example method for managing locks for exclusive access to shared resources in a queue-enabled system, in accordance with some embodiments of the present disclosure;

FIG. 8 is a flow diagram illustrating an example method for geometric-based management of concurrent map updates, in accordance with some embodiments of the present disclosure;

FIG. 9 is a flow diagram illustrating an example method for enforcing causal ordering of concurrent map updates using geometric identifiers, in accordance with some embodiments of the present disclosure;

FIG. 10A is an illustration of an example autonomous vehicle, in accordance with some embodiments of the present disclosure;

FIG. 10B is an example of camera locations and fields of view for the example autonomous vehicle of FIG. 10A, in accordance with some embodiments of the present disclosure;

FIG. 10C is a block diagram of an example system architecture for the example autonomous vehicle of FIG. 10A, in accordance with some embodiments of the present disclosure;

FIG. 10D is a system diagram for communication between cloud-based server(s) and the example autonomous vehicle of FIG. 10A, in accordance with some embodiments of the present disclosure;

FIG. 11 is a block diagram of an example computing device suitable for use in implementing some embodiments of the present disclosure;

FIG. 12 is a block diagram of an example data center suitable for use in implementing some embodiments of the present disclosure; and

FIG. 13 illustrates an example of a system that may perform one or more of the processes described herein, in accordance with some embodiments of the present disclosure.

### DETAILED DESCRIPTION

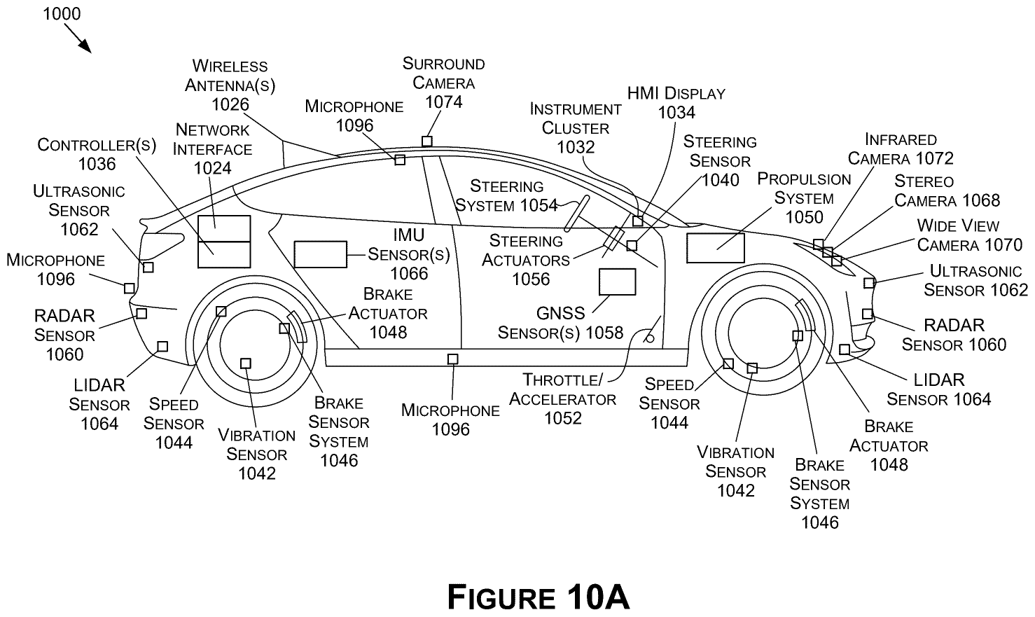

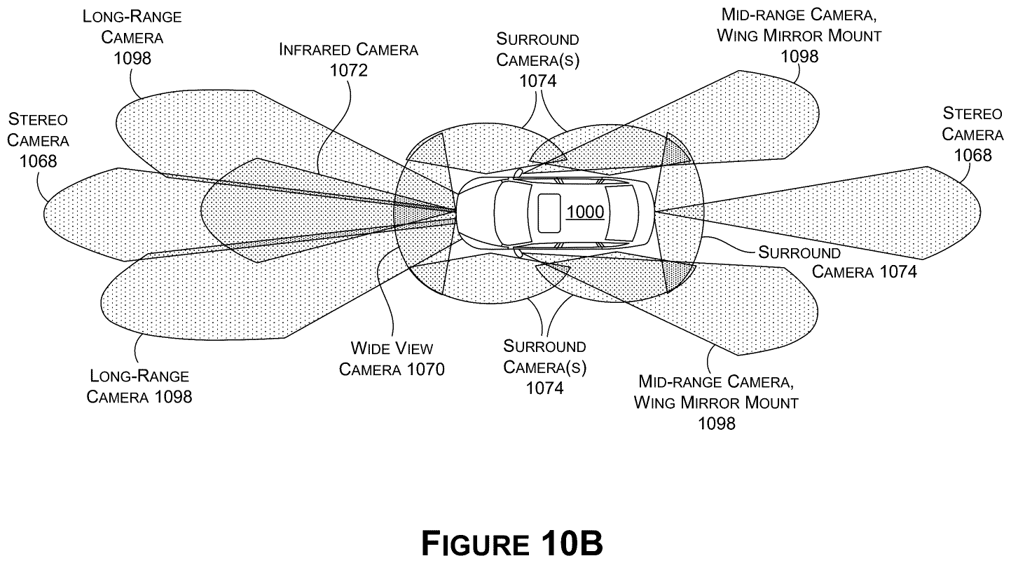

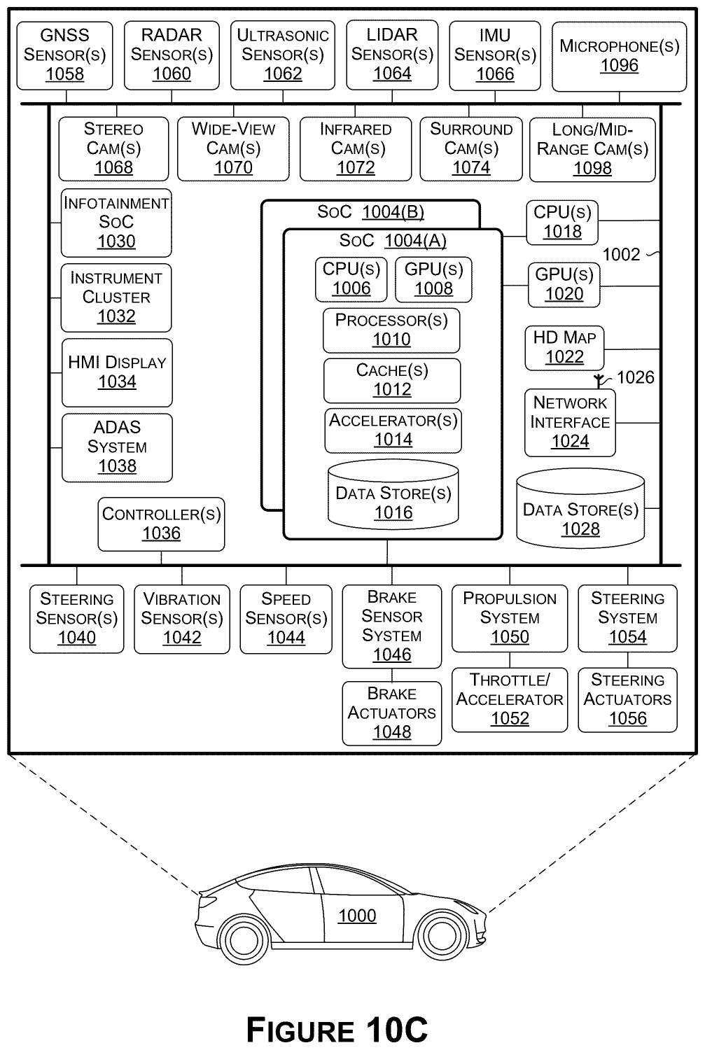

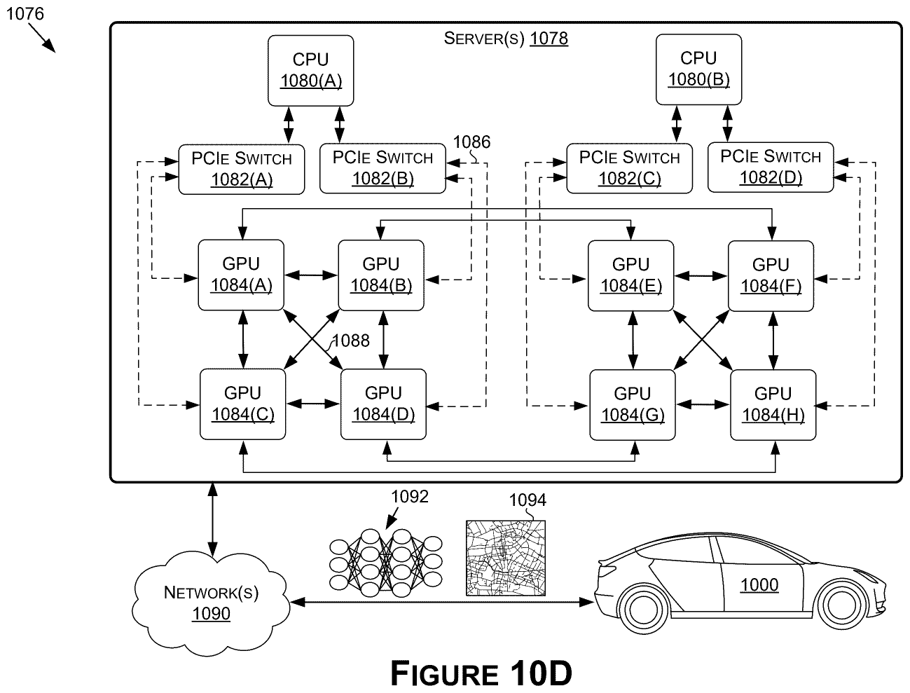

Systems and methods are disclosed related to geometric-based management of concurrent map updates for autonomous and semi-autonomous systems and applications. Although the present disclosure may be described with respect to an example autonomous or semi-autonomous vehicle or machine 1000 (alternatively referred to herein as “vehicle 1000,” “ego-vehicle 1000,” “ego-machine 1000,” or “machine 1000,” an example of which is described with respect to FIGS. 10A-10D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to map generation/updating, this is not intended to be limiting, and the systems and methods described herein may be used in augmented reality, virtual reality, mixed reality, robotics, security and surveillance, autonomous or semi-autonomous machine applications, and/or any other technology spaces where object detection and/or map creation may be used.

For instance, a system(s) for geometric-based management of concurrent map updates may be configured to enforce a causal ordering of operations (e.g., updates, update operations, etc.) working on the same resources (e.g., map resources, map data, etc.) such that the operations are applied in a specific and consistent ordering. In some examples, the ordering of the operations may be determined in a number of ways. For instance, operations may be applied in the order they are received. Additionally, or alternatively, the operations may be applied in an order that is based on priority, based on a schedule/reservation, and/or any other causal ordering.

As described herein, to enforce the causal ordering of the operations, the system(s) may use a geometric-based approach that also includes switching a state associated with a map resource corresponding to a specified geometric area from a first—or unlocked—state to a second—or locked—state. In some examples, the system(s) may use mutual exclusion locks (also referred to herein as “mutexes”) to manage access to the map resources. For instance, before a first operation may be applied to a shared map resource, the first operation may be required to obtain the mutex lock associated with that map resource. If the mutex is not already locked for a second operation, the first operation may successfully acquire the lock and proceed. If, however, the mutex is already locked for the second operation, the first operation attempting to acquire the lock may be suspended or denied until the mutex lock becomes available. Once the second operation has finished updating the shared resource, the second operation may release the mutex lock, allowing the first operation to acquire the mutex and update the resource.

In some examples, the system(s) may include or use one or more databases for organizing and storing the map resources or other information pertaining to the maps. For instance, the database may store the maps as individual tiles of data/resources, where each tile corresponds to a different region of an environment. The databases may include, in some examples, open-source object-relational databases that safely store and scale various data workloads. Additionally, the databases may allow for performance of atomic, row-level operations and transactions.

To scale database connections and manage the load of many different requests, the system(s) may include a service fronting the databases. Additionally, the service may be fronted by one or more load balancers. In this way, the service and/or load balancers of the system(s) may provide a common interface to the databases storing the map resources. As described herein, the system(s) may scale the service in a number of ways. For example, the system(s) may run multiple instances of the service on a cluster (e.g., a container orchestration system cluster, such as Kubernetes, Docker Swarm, etc.) and automatically scale the number of instances up or down as load increases or decreases, respectively. Additionally, in some examples, as scaling needs grow, the system(s) may scale the service architecture across data center availability zones for high availability concerns, replicate the service architecture in the same region as cells for reduced blast radius, and/or replicate the service architecture in multiple regions for reduced latency and regional alignment. The system(s) may also, in some instances, include a client side and/or service side router to route requests for a given resource to the correct services and/or databases managing that resource.

In some examples, the system(s) may represent a lock for some region of a map using Geographic Information System (GIS)-based extensions for the databases. The GIS-based extensions may allow the system(s) to represent data as geometric resources, as well as ask questions about the geometric resources. In some examples, the system(s) may represent maps as Mercator Projections (e.g., Web Mercator, Spherical Mercator, etc.) or other projections (e.g., Gall-Peters Projections, Robinson Projections, etc.) at a specific tile level/zoom. This may allow the system(s) to insert rows indexed by lock identifiers, which may afford efficient polling on lock state. Additionally, representing the maps as Web Mercator Projection may also allow the system(s) to insert rows indexed by the geometry requested on a lock. As described herein, to associate locks with multiple different regions, the system(s) may leave open a namespace field for use by applications or clients to define. For instance, the namespace field may be defined as a unique identifier corresponding to a map tile(s).

By way of example, and not limitation, the system(s) may receive a first request from a first client (e.g., device, system, endpoint, etc.) to update first map resources corresponding to a first geographic region of an environment. The first request may include a first geometric description (also referred to herein as a “geometric identifier”) of the first geographic region. In some examples, the first map resources may include or correspond to one or more first tiles of a map (e.g., tiles of a Mercator map projection) stored in the databases associated with the system(s). In some examples, the first request may include an indication of a priority for the request. That is, the indication may indicate whether the first request is a low priority request, a medium priority request, a high priority request, etc. In some examples, the first request may include a requested time for making the updated to the first map resources. That is, and as discussed in further detail herein, the first client may include in the request an indication of a requested time for the system(s) to obtain a lock on the first map resources for the first client to make the update.

In some examples, the system(s) may use the first geometric description included in the first request to determine whether to lock the first map resources for updating by the first client. For instance, the system(s) may determine whether a lock is already held for the first map resources—or at least a portion of the first map resources—by evaluating the first geometric description included in the first request with geometric descriptions associated with any active locks. In some instances, matching geometric descriptions between the requested lock and an active lock may indicate the presence of the active lock for the first resources. Additionally, or alternatively, the system(s) may evaluate the underlying geographic regions and/or map tiles corresponding to the geometric descriptions to determine if there is overlap and a lock is held. For instance, consider a map having 9 tiles (e.g., 3×3). If the active lock is held for all 9 of the tiles, but the requested lock is only for 4 of the tiles (e.g., 2×2), the geometric descriptions associated with the active lock and the requested lock may differ. As such, the system(s) may evaluate the underlying data the geometric descriptions point to, in some instances, to determine whether there is overlap.

In various examples, the system(s) may determine that no active lock is in place with respect to the first map resources and grant the requested lock for the first client to update the first map resources. After granting the lock, the first client may then access the first map resources and apply one or more operations to update the first map resources. For instance, the first client may update the first map resources using data (e.g., mapstream data, sensor data, location data, perception data, etc.) generated using one or more machines operating in the first geographic region of the environment. Additional detail relating to generating and/or updating maps based on data generated using machines operating in an environment is described in U.S. patent application Ser. No. 18/538,558, which is incorporated herein by reference in its entirety and for all purposes.

As described herein, the system(s) may receive a second request from a second client to update second map resources corresponding to a second geographic region of an environment. The second request may include a second geometric description of the second geographic region. In some examples, the second map resources may include or correspond to one or more second tiles of the map. As with the first request, the second request may also include an indication of a priority for the request and/or a requested time for locking the second map resources to make the update. Based at least on receiving the second request, the system(s) may use the second geometric description included in the second request to determine whether to lock the second map resources for updating by the second client. For instance, the system(s) may determine whether a lock is already held for the second map resources—or at least a portion of the second map resources—by evaluating the second geometric description included in the second request with geometric descriptions associated with any active locks.

In some examples, the system(s) may determine that at least a portion of the second map resources are locked for updating by the first client. For instance, the system(s) may determine that the second map resources overlap with the first map resources based at least on the first and second geometric descriptions. That is, the system(s) may determine that the first geometric description and the second geometric description are matching geometric descriptions and/or point to one or more overlapping geographic areas of the environment and/or tiles of the map, etc. Based at least on determining that the portion of the second map resources is locked for updating, the system(s) may deny the second request of the second client to lock the second map resources.

As described herein, in some examples, the system(s) may use one or more techniques to ensure that progress associated with updating maps may continue, such as without delay, in order to maintain the most updated maps. For instance, the system(s) may set a timeout period and/or a deadline for the lock associated with the first map resources. If the timeout period or deadline is met or exceeded (e.g., by inactivity of the first client, lack of response from the first client, etc.), then the first map resources may be unlocked and other clients and/or operations may obtain a subsequent lock that includes the first map resources. As an example, a deadline (e.g., 10 minutes, 20 minutes, 30 minutes, etc.) may be established for the lock of the first map resources obtained by the first client. The deadline may be extendable by the first client upon request and/or automatically based on activity. If the first client finishes the update before the deadline, the first client may unlock the first map resources and the second client may be allowed to resubmit and obtain the lock for the second map resources. However, if the deadline expires prior to the first client finishing the update and without extension, the system(s) may force remove the lock on the first map resources and revert the first map resources to their latest state prior to the attempted update by the first client. After the unlock, if the system(s) does not implement a lock queue, any client (e.g., the first client, the second client, third clients, etc.) may be allowed to submit a request for, and obtain, a lock that includes the first map resources. In some instances, an initial duration of the timeout period and/or deadline may vary based on various factors, including, but not limited to, the amount of map resources involved in the lock, a priority associated with the lock or lock request, the geometric or geographic area involved in the lock, a requested or estimated duration for applying an update, and/or any other factors.

In some examples, the system(s) may implement a lock request queue to maintain an order in which lock requests are submitted or received to promote work fairness. That is, without queuing, there may be no mechanism in place to prevent earlier-submitted lock requests from being served after later-submitted lock requests. Using a lock request queue, instead of clients requesting various operations to try to create a lock, the clients may instead create a lock request which may always be created and a tracking identifier returned. At this point the operation may poll the system(s) to determine whether the lock for the requested resource has been granted and, if not, what is the estimated time that the lock may be obtained.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models, such as large language models (LLMs), vision language models (VLMs), and/or multi-modal language models, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

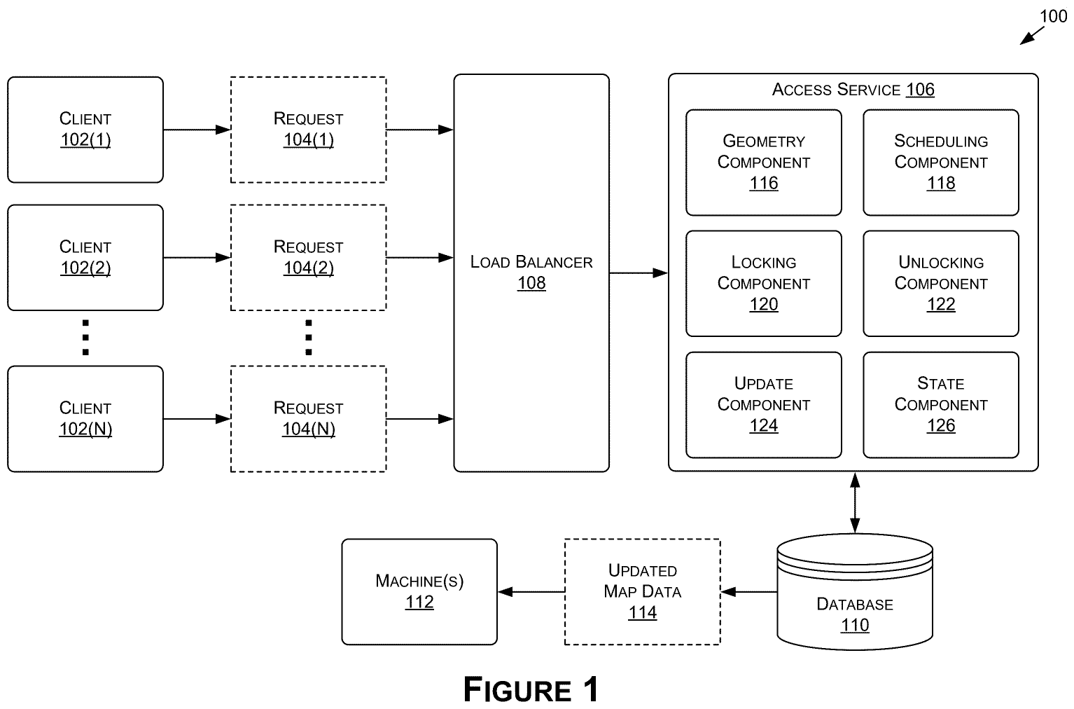

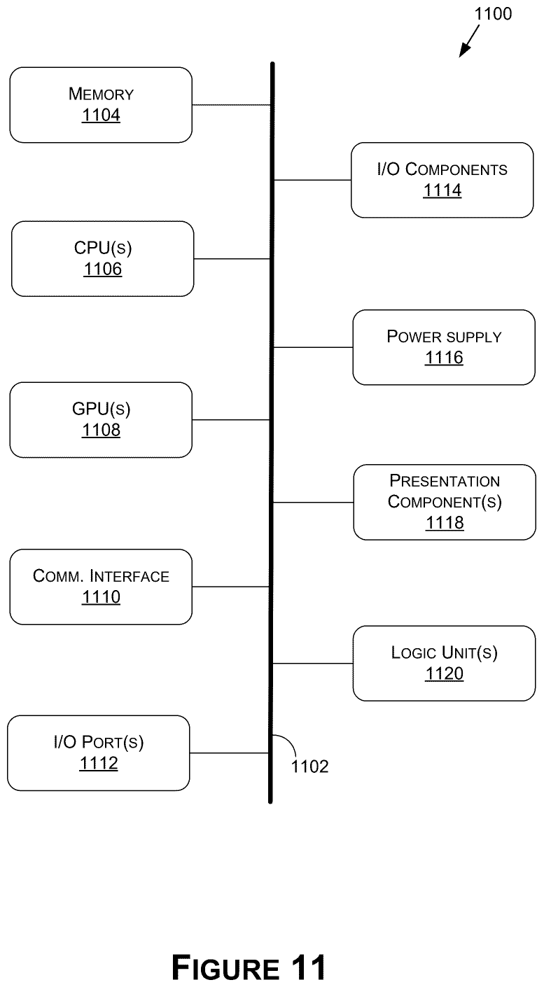

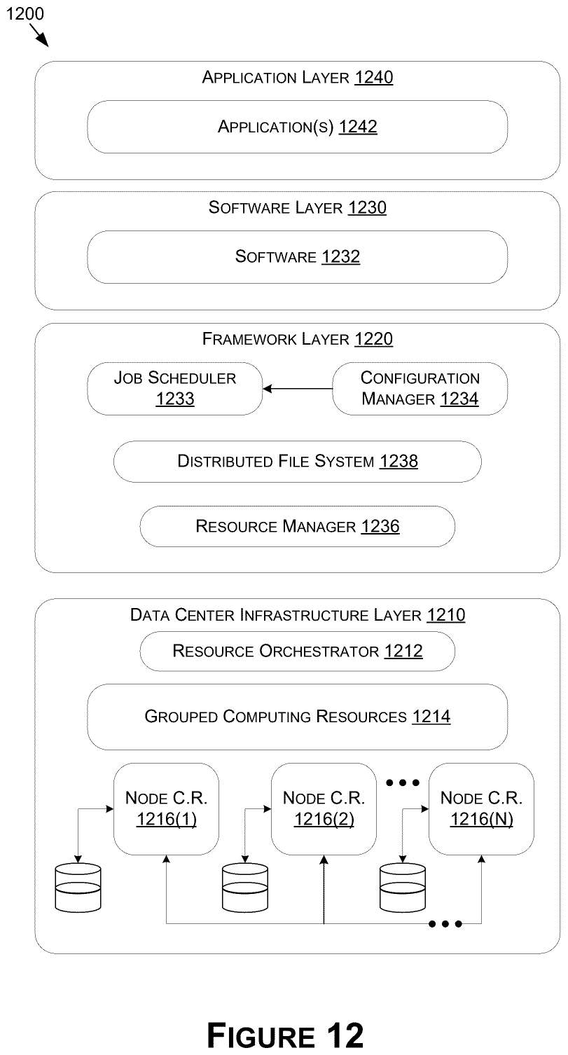

With reference to FIG. 1, FIG. 1 is a data flow diagram illustrating an example of a process 100 for managing concurrent map updates, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 1000 of FIGS. 10A-10D, example computing device 1100 of FIG. 11, and/or example data center 1200 of FIG. 12.

The process 100 may include one or more clients 102(1)-102(N) sending one or more requests 104(1)-104(N) to an access service 106 via a load balancer 108. As used herein, use of “N” in a reference label, such as the client 102(N) or the request 104(N), may denote any number or quantity. The access service 106 may manage access to various map-related resources stored in a database 110. For instance, the requests 104 may include lock requests for the access service 106 to obtain a lock (e.g., mutex) for the clients 102 to update one or more map resources stored in the database 110. The access service 106 may be configured to obtain the requested locks in the order they are received, based on priority, based on a schedule/reservation, or any other causal order. Once an exclusive lock is obtained, the clients 102 may then update the map resources (also referred to herein as “map data”), and one or more machines 112 (which may correspond to the autonomous vehicle 1000 in the examples of FIGS. 10A-10D) may obtain the updated map data 114 from the database 110 to use to traverse an environment.

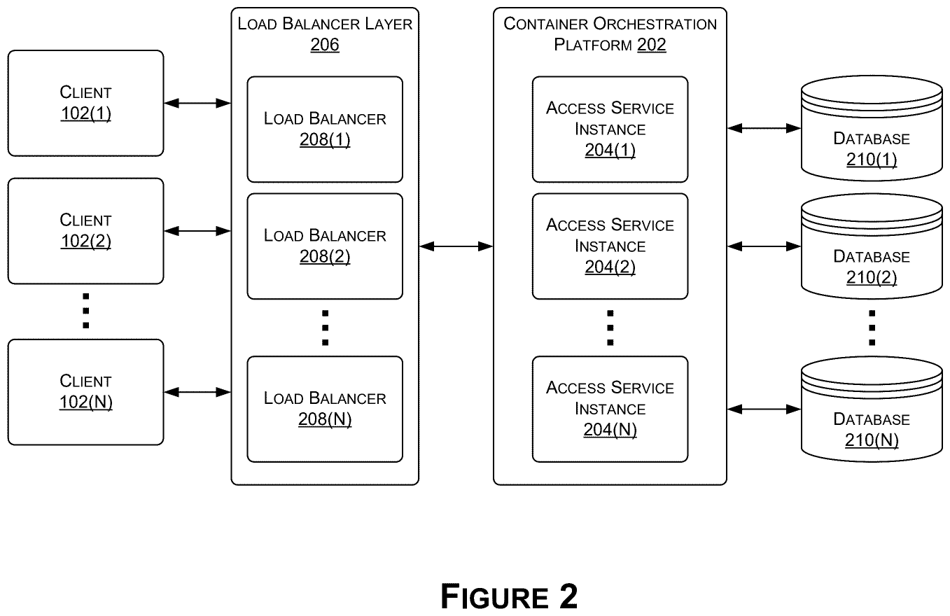

In various examples, the access service 106, the load balancer 108, the database 110, and/or any other components may be scaled in a number of ways. For instance, FIG. 2 illustrates an example of scaling various aspects of a system, in accordance with some embodiments of the present disclosure. As shown, a container orchestration platform 202 may be used to host and to scale multiple access service instances 204(1)-204(N). The access service instances 204 may correspond to the access service 106 in the example of FIG. 1. The container orchestration platform 202 may comprise any system for hosting containerized services, such as Kubernetes, Docker Swarm, etc. Additionally, a load balancer layer 206 may include multiple load balancers 208(1)-208(N), which may correspond to the load balancer 108. Each of the load balancers 208 may represent a physical load balancing device, a virtual load balancing device, a load balancing workload, etc. Further, multiple databases 210(1)-210(N), which may correspond to the database 110, may be used to store the map resources.

In some examples, the container orchestration platform 202 may automatically scale the number of the access service instances 204 up and down as load increases or decreases. Additionally, in some examples, as scaling needs grow, the container orchestration platform 202 may scale the service architecture across data center availability zones for high availability concerns, replicate the service architecture in the same region as cells for reduced blast radius, and/or replicate the service architecture in multiple regions for reduced latency and regional alignment.

In some instances, as the number of systems and resources being managed increases, the number of databases 210 may be increased. This may be accomplished using a number of solutions for increasing the database scalability. For instance, the underlying hardware of the databases 210 may be increased, which may be referred to as “vertical scaling.” Additionally, or alternatively, the resource namespaces may be partitioned among the various database instances, which may also be referred to as “horizontal scaling.” As another example, the databases 210 may be sharded by region (e.g., as map resources have strict locality). In some examples, if different scaling is required for the database, different encoding of geometry may be used, such as GeoHashes.

Referring back to the example of FIG. 1, the clients 102 may correspond to various computing devices, servers, endpoints, or any other client systems that may access the access service 106 over one or more networks. In some examples, the clients 102 may interact with the access service 106 using various protocols (e.g., HTTP), application programming interfaces (APIs), or dedicated applications, enabling remote access and diverse functionalities. In some examples, each one of the clients 102 may represent a disparate autonomous system that is configured to update the map resources stored in the database 110. For instance, these autonomous systems may include one or more server computers, autonomous machines, machine learning models, or any other components, devices, or systems for automatically generating map data and updating the map data stored in the database 110. In at least one example, each one of the clients 102 may be associated with a different geographic location (e.g., disposed in different geographic regions and configured to generate maps for those regions). Alternatively, or additionally, the clients 102 may be associated with a same geographic region but managed by different entities (e.g., entity A's system, entity B's system, etc.).

In various examples, the requests 104 may correspond to lock requests as described above and herein. As such, the requests 104 may include, among other things, an indication of target map resources to be locked, a geometric description of the target map resources to be locked, a geographic region corresponding to the target map resources to be locked, tile identifiers corresponding to the target map resources to be locked, or any other pertinent information for identifying the map resources the clients 102 are requesting to lock for an update or other operation.

In some examples, the requests 104 may include an indication of a priority for the lock and/or the update/operations that is to be performed. That is, the indication may indicate whether the requests 104 are low priority, medium priority, high priority, etc. The priority level of the request may be indicated in a number of ways, such as on a sliding scale (e.g., 1-10, low, medium, high, etc.). In some examples, the requests 104 may include a requested time for the lock. For example, the clients 102 may include in the requests 104 an indication of a requested time for the access service 106 to obtain the lock on the map resources for. In some instances, the requested time may be specified (e.g., by the client) or estimated (e.g., by the access service 106) based on the amount of map resources requested to be locked. For example, a first amount of time may be estimated for a request to lock a first number of map tiles, while a second amount of time that is greater than the first amount of time may be estimated for a request to lock a second number of map tiles that is greater than the first number of tiles. In some examples the requested or estimated time for a lock may be used to establish a timeout period or deadline for the lock, as described in more detail herein.

As described herein, to enforce the causal ordering of the operations, the access service 106 may use a geometric-based approach that also includes switching a state associated with a map resource corresponding to a specified geometric area from a first—or unlocked—state to a second—or locked—state. In some examples, the access service 106 may use mutual exclusion locks (also referred to herein as “mutexes”) to manage access to the map resources. For instance, before a first operation may be applied to a shared map resource, the first operation may be required to obtain the mutex lock associated with that map resource. If the mutex is not already locked for a second operation, the first operation may successfully acquire the lock and proceed. If, however, the mutex is already locked for the second operation, the first operation attempting to acquire the lock may be suspended or denied until the mutex lock becomes available. Once the second operation has finished updating the shared resource, the second operation may release the mutex lock, allowing the first operation to acquire the mutex and update the resource.

In some examples, the access service 106 may front the database 110 for organizing and storing the map resources or other information pertaining to the maps. For instance, the database 110 may store the maps as individual tiles of data/resources, where each tile corresponds to a different region of an environment. The database 110 may, in some examples, be an open-source, object-relational database that safely stores and scales various data workloads. Additionally, the database 110 may allow for performance of atomic, row-level operations and transactions.

In some examples, the access service 106 may represent a lock for some region of a map using Geographic Information System (GIS)-based extensions for the database 110. The GIS-based extensions may allow the access service 106 to represent data as geometric resources, as well as ask questions about the geometric resources. In some examples, the access service 106 may represent maps as Mercator Projections (e.g., Web Mercator, Spherical Mercator, etc.) or other projections (e.g., Gall-Peters Projections, Robinson Projections, etc.) at a specific tile level/zoom. This may allow the access service 106 to insert rows indexed by lock identifiers, which may afford efficient polling on lock state.

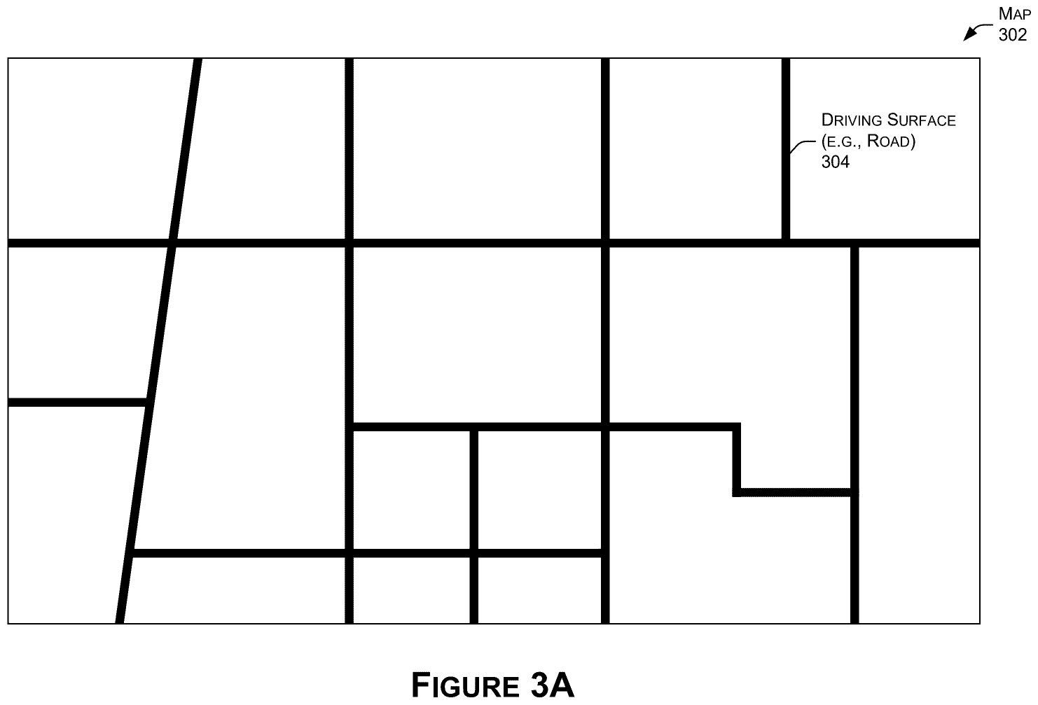

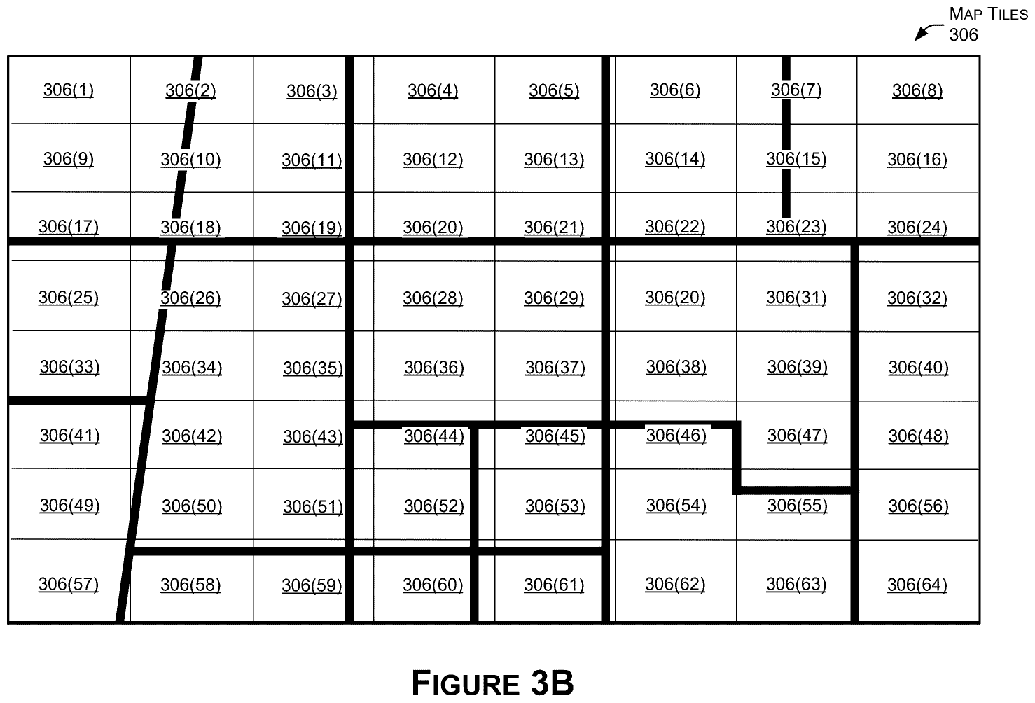

For instance, FIG. 3A illustrates an example map 302 of an environment, in accordance with some embodiments of the present disclosure. In the context of maps for autonomous or semi-autonomous machines, the map 302 may represent a network of driving surfaces in an environment, such as the driving surface 304. Additionally, the map 302 may represent other information associated with the environment that is not shown in the example of FIG. 3A, such as building locations, traffic sign locations, traffic light locations, construction zone locations, or any other information. Referring now to FIG. 3B, the map 302 may be portioned into multiple map tiles 306, in accordance with some embodiments of the present disclosure. In some examples, each one of the individual map tiles 306(1)-306(64) may correspond to a specific portion of the map 302. Additionally, each of the map tiles 306(1)-306(64) may correspond to a specific geographic region of the environment. Although illustrated in the example of FIG. 3B as being rectangles of equivalent sizes, the individual map tiles 306(1)-306(64) may be of any shape or size, in some examples. For instance, the map tiles 306 may be level 16 or any other level of Mercator Projection tiles, or any other projection of tiles.

Referring back to the example of FIG. 1, the access service 106 may receive one or more of the requests 104 and use one or more of its components, such as a geometry component 116, a scheduling component 118, a locking component 120, an unlocking component 122, and an update component 124, to determine whether to obtain one or more locks in accordance with the requests 104. For instance, the access service 106 may use the geometry component 116 to identify underlying map resources that geometric descriptions (included in the requests 104) correspond to.

The access service 106 may use the scheduling component 118 to perform various functionality with respect to scheduling locks, determining whether an active lock exists for a geometric area, queuing lock requests, organizing request based on priority, or any other operations related to causal ordering of lock requests. For instance, the scheduling component 118 may implement the lock request queue to maintain an order in which requests 104 are submitted or received to promote work fairness. Upon receiving the requests 104, the scheduling component 118 may acknowledge the request 104 and return a tracking identifier for the lock request. If a lock is not issued immediately upon request, the clients 102 may poll the access service 106 via the scheduling component 118 to determine whether the lock for the requested resource has been granted and, if not, what is the estimated time that the lock may be obtained.

The scheduling component 118 may also manage and determine when one lock should take priority over another lock. For example, the scheduling component 118 may determine that one lock request should be moved ahead of another (earlier submitted) lock request in the queue if the later submitted lock request is for, among other things, an urgent fix or update that needs to be published, an operations task that needs to halt production deployments, etc. In a similar way, the scheduling component may defer a number of less urgent tasks whenever there is capacity. In order to achieve this, the requests 104 may be inserted with a defined priority, which may be as simple as a number in the range of 1 to 100, and the scheduling component 118 may use this priority as an ordering heuristic in the lock queue system.

The scheduling component 118 may also allow for the clients 102 to schedule locks in advance. For instance, using the lock queue mechanism, deferred or scheduled locks may be created by the clients 102 and managed by the scheduling component 118. To schedule a time, the clients 102 may include, within a field in the requests 104, an indication of the time that must be reached before this lock can be taken. By default, the clients 102 may set this field to the current time to effectively disable delaying the lock. The data contained within this field may then be added to the lock queue ordering heuristic by the scheduling component 118. In some instances, higher priority may be assigned to scheduled locks so that only very high priority operations may interfere with a clients scheduled lock.

The locking component 120 and the unlocking component 122 of the access service 106 may manage the locking and unlocking of the map resources. In some examples, the locking component 120 and the unlocking component 122 may work together to ensure that only one client has access to a shared map resource at any given time. Although depicted as separate components in the example of FIG. 1, the locking component 120 and the unlocking component 122 may be the same component (e.g., same workload, device, mechanism, etc.). In some examples, the locking component 120 may issue mutexes to the clients 102 when the mutexes are available, and the unlocking component 122 may retrieve or clear the mutexes to release a lock on shared resources. In various examples, the unlocking component 122 may have the ability to force remove locks in certain scenarios, such as when a timeout period or a lock deadline is reached.

The update component 124 may facilitate updating the map resources of the database 110. In some examples, the clients 102 may update the map resources directly in the database 110. Additionally, or alternatively, the client devices 102 may submit operations or updates to the update component 124, and the update component 124 may apply the operations or updates to the map resources of the database 110.

By way of example, and not limitation, the access service 106 may receive a first request 104(1) from a first client 102(1) to update first map resources corresponding to a first geographic region of an environment. For instance, and with reference to FIG. 3B, the first request 104(1) may be to update map tiles 306(1)-306(3), 306 (9)-306(11), and 306(17)-306(19). That is, the first map resources may include or correspond to map tiles 306(1)-306(3), 306(9)-306(11), and 306(17)-306(19) stored in the database 110. The first request 104(1) may include a first geometric description of the first geographic region. The geometry component 116 of the access service 106 may use the first geometric description to identify the map resources requested to be locked. In some examples, the first request 104(1) may include an indication of a priority for the request. That is, the indication may indicate whether the first request 104(1) is a low priority request, a medium priority request, a high priority request, etc. In some examples, the first request 104(1) may include a requested time for making the updated to the first map resources. That is, and as discussed in further detail herein, the first client 102(1) may include in the request an indication of a requested time for the access service 106 to obtain a lock on the first map resources for the first client 102(1) to make the update.

In some examples, the access service 106 may use the first geometric description included in the first request 104(1) to determine whether to lock the first map resources for updating by the first client 102(1). For instance, the scheduling component 118 may determine whether a lock is already held for the first map resources—or at least a portion of the first map resources-by using the geometry component to evaluate the first geometric description included in the first request 104(1) with geometric descriptions associated with any active locks. In some instances, matching geometric descriptions between the requested lock and an active lock may indicate the presence of the active lock for the first resources. Additionally, or alternatively, the access service 106 may evaluate the underlying geographic regions and/or map tiles corresponding to the geometric descriptions to determine if there is overlap and a lock is held. For instance, consider a map having 9 tiles (e.g., 3×3). If the active lock is held for all 9 of the tiles, but the requested lock is only for 4 of the tiles (e.g., 2×2), the geometric descriptions associated with the active lock and the requested lock may differ. As such, the access service 106 may use the geometry component 116 to evaluate the underlying data the geometric descriptions point to, in some instances, to determine whether there is overlap.

In various examples, the access service 106 may determine that no active lock is in place with respect to the first map resources and use the locking component 120 to grant the requested lock for the first client 102(1) to update the first map resources. After granting the lock, the first client 102(1) may then access the first map resources and apply one or more operations to update the first map resources. For instance, the first client 102(1) may update the first map resources using data (e.g., mapstream data, sensor data, location data, perception data, etc.) generated using one or more machines operating in the first geographic region of the environment. Additional detail relating to generating and/or updating maps based on data generated using machines operating in an environment is described in U.S. patent application Ser. No. 18/538,558, which is incorporated herein by reference in its entirety and for all purposes.

As described herein, the access service 106 may receive a second request 104(2) from a second client 102(2) to update second map resources corresponding to a second geographic region of an environment. The second request 104(2) may include a second geometric description of the second geographic region. In some examples, the second map resources may include or correspond to one or more second tiles of the map. The access service 106 may use the geometry component 116 to identify the second geographic region, the second map tiles, the second map resources, etc. based on the second geometric description. As with the first request 104(1), the second request 104(2) may also include an indication of a priority for the request and/or a requested time for locking the second map resources to make the update. Based at least on receiving the second request 104(2), the access service 106 may use the second geometric description included in the second request 104(2) to determine whether to lock the second map resources for updating by the second client 102(2). For instance, the access service 106 may determine whether a lock is already held for the second map resources—or at least a portion of the second map resources—by using the geometry component 116 and/or the scheduling component to evaluate the second geometric description included in the second request 104(2) with geometric descriptions associated with any active locks.

In some examples, the access service 106 may determine that at least a portion of the second map resources are locked for updating by the first client 102(1). For instance, the access service 106 may determine, using the geometry component 116, that the second map resources overlap with the first map resources based at least on the first and second geometric descriptions. That is, the access service 106 may determine that the first geometric description and the second geometric description are matching geometric descriptions and/or point to one or more overlapping geographic areas of the environment and/or tiles of the map, etc. Based at least on determining that the portion of the second map resources are locked for updating, the access service 106 may deny the second request 104(2) of the second client 102(2) to lock the second map resources.

As described herein, the access service 106 may set a timeout period and/or a deadline for the lock associated with the first map resources. For instance, the scheduling component 118 of the access service 106 may establish the timeout period or the deadline. If the timeout period or deadline is met or exceeded (e.g., by inactivity of the first client 102(1), lack of response from the first client 102(1), etc.), then the access service 106 may use the unlocking component 122 to unlock the first map resources, and other clients and/or operations may obtain a subsequent lock that includes the first map resources. As an example, a deadline (e.g., 10 minutes, 20 minutes, 30 minutes, etc.) may be established for the lock of the first map resources obtained by the first client 102(1). The deadline may be extendable by the first client 102(1) upon request and/or automatically based on activity. If the first client 102(1) finishes the update before the deadline, the first client 102(1) may unlock the first map resources and the second client 102(2) may be allowed to resubmit and obtain the lock for the second map resources. However, if the deadline expires prior to the first client 102(1) finishing the update and without extension, the access service 106 may use the unlocking component 122 to force remove the lock on the first map resources and the state component 126 may revert the first map resources to their latest state prior to the attempted update by the first client 102(1). After the unlock, if the access service 106 does not implement a lock queue, any client (e.g., the first client 102(1), the second client 102(2), third clients, etc.) may be allowed to submit a request for, and obtain, a lock that includes the first map resources. In some instances, an initial duration of the timeout period and/or deadline may vary based on various factors, including, but not limited to, the amount of map resources involved in the lock, a priority associated with the lock or lock request, the geometric or geographic arca involved in the lock, a requested or estimated duration for applying an update, and/or any other factors.

In some examples, the access service 106 may use the scheduling component 118 to implement a lock queue to maintain an order in which lock requests are submitted or received to promote work fairness. In such an example, instead of denying the second request 104(2), the second request 104(2) may be placed in the queue and a tracking identifier may be returned to the second client 102(2). The second client 102(2) may then poll the access service 106 to determine when it may obtain the lock. Once the lock is released on the first resources, the second client 102(2) may advance in the queue and, if it is next in line, obtain the lock for updating the second map resources.

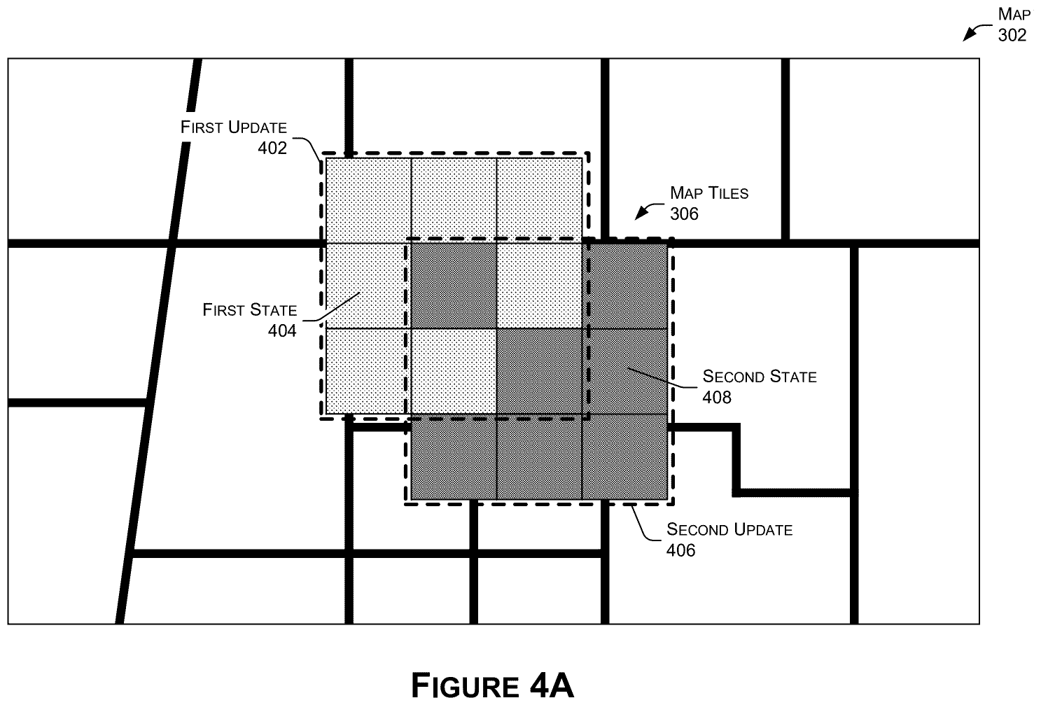

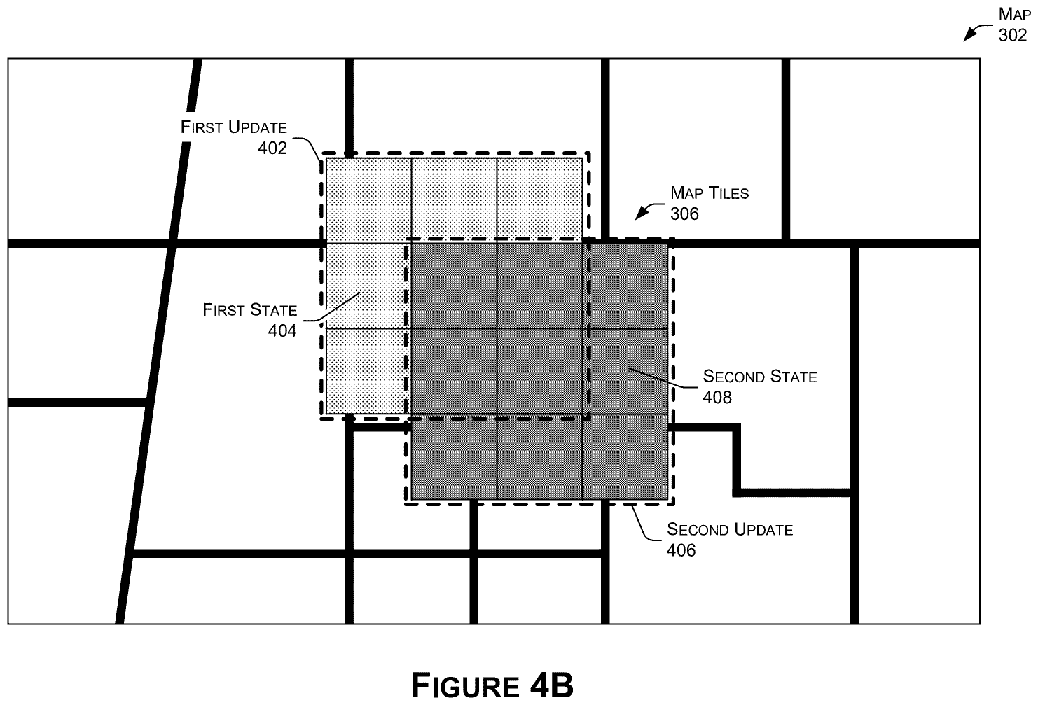

By using the access service 106 to enforce causal ordering of updates to the shared map resources, the integrity of the map resources may be better maintained in a correct state and the access service 106 may ensure that updates to the map resources do not leave the map resources corrupted, which could lead to any number of adverse events, including driving disconnects, potentially fatal driving errors, or any other adverse events. For instance, FIGS. 4A and 4B illustrate an example comparison of resultant states of map tiles responsive to updates performed in a random order and updates performed according to an enforced, causal ordering, in accordance with some embodiments of the present disclosure. Referring first to FIG. 4A, a first update 402 may be applied to first map resources to update a first subset of the map tiles 306 to a first state 404, and a second update 406 may be applied concurrently to second map resources to update a second subset of the map tiles 306 to a second state 408. However, because the first subset of the map tiles 306 overlaps with the second subset of the map tiles 306, if a causal ordering is not enforced for the first update 402 and the second update 406, some of the tiles of the second subset of the map tiles 306 may not be updated to the second state 408. That is, the first update 402 may be applied to those overlapping tiles after the second update 4086 resulting in the tiles being in the first state 404 and potentially corrupt. In contrast, referring to FIG. 4B, causal ordering is enforced to apply all of the first updates 402 before the second updates 406. As such, the map tiles 306 are all updated to the correct and intended state.

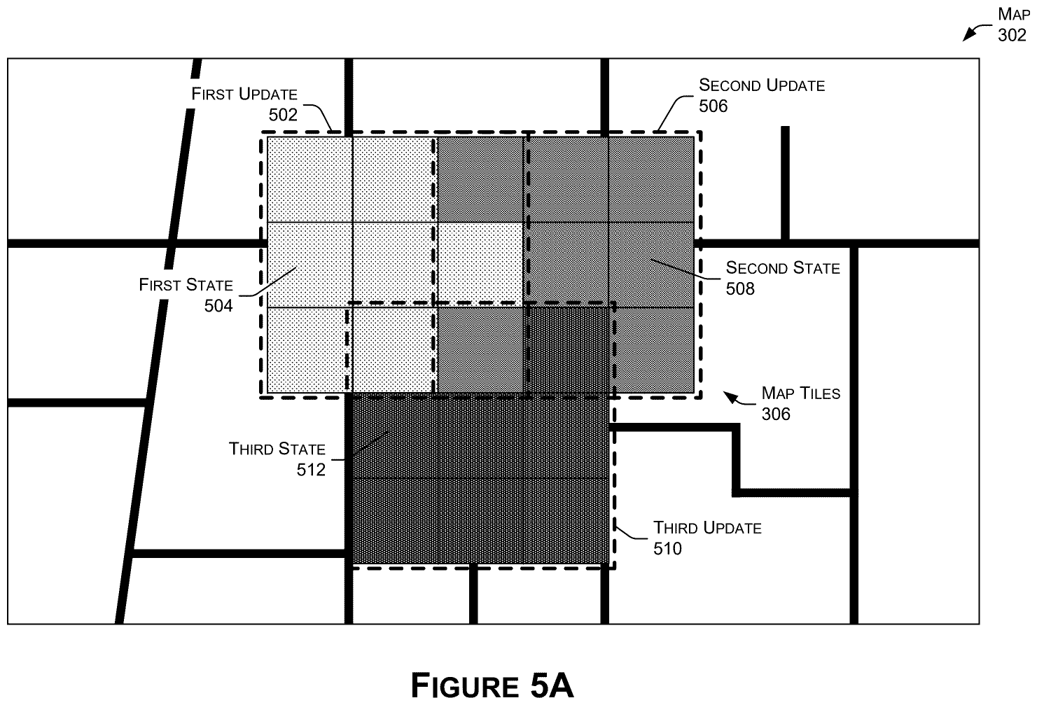

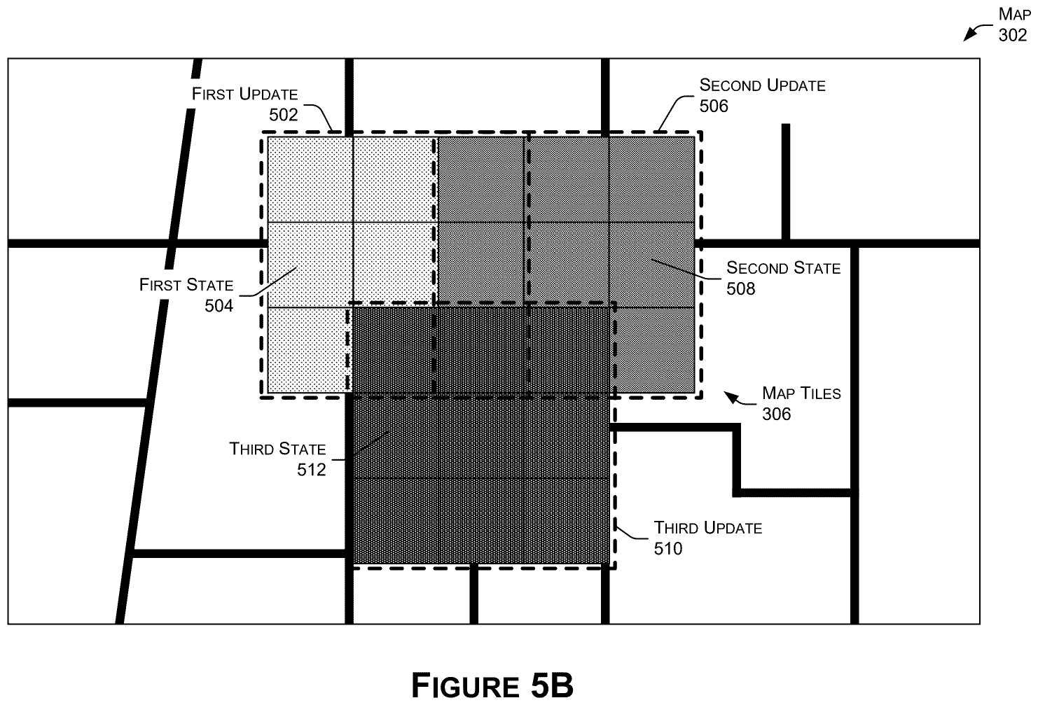

Additionally, FIGS. 5A and 5B illustrate another example comparison of resultant states of map tiles responsive to updates performed in a random order and updates performed according to an enforced, causal ordering, in accordance with some embodiments of the present disclosure. Referring first to FIG. 5A, concurrently, a first update 502 may be applied to first map resources to update a first subset of the map tiles 306 to a first state 504, a second update 506 may be applied to second map resources to update a second subset of the map tiles 306 to a second state 508, and a third update 510 may be applied to third map resources to update a third subset of the map tiles 306 to a third state 512. However, because the first subset, the second subset, and the third subset of the map tiles 306 all at least partially overlap with one another, if a causal ordering is not enforced for the first update 502, the second update 506, and the third updated 510, some of the tiles may not be updated to the correct or intended state. That is, the first update 502 may be applied to some overlapping tiles after the second update 506 and/or the third update 510 and/or the second update 506 may be applied to some tiles after the third update 510, resulting in the tiles being in incorrect states and, potentially, corrupt. In contrast, referring to FIG. 5B, causal ordering is enforced to apply all of the first updates 502 before the second updates 506, and all of the second updates 506 before the third updates 510. As such, the map tiles 306 are all updated to the correct and intended state in the example of FIG. 5B.

Referring back to the example of FIG. 1, the process 100 may include the machine(s) 112 obtaining the updated map data 114. The updated map data 114 may be generated based at least on the clients 102 obtaining the locks for the map resources in the database 110 and updating the map resources while the locks are active. In some examples, the machine(s) 112 may correspond to the example autonomous or semi-autonomous vehicle 1000 described herein with respect to FIGS. 10A 10D. In some examples, the machine(s) 112 may perform one or more operations using the updated map data 114. For instance, the machine(s) 112—or one or more components of the machine(s) 112—may plan a path for the machine(s) 112 to follow through an environment. Additionally, the machine(s) 112 may use the updated map data 114 to verify sensor data generated using one or more sensors of the machine(s) 112, or to validate perception data generated based at least on the second data. In some instances, the machine(s) 112 may better or more accurately determine a localization or pose of the machine(s) 112 using the updated map data 114. For instance, if the machine(s) 112 attempt to localize using old map data, the machine(s) 112 may fail as the sensor data and/or perception data may not match the old map data. However, the updated map data 114 may more closely resemble or match the sensor/perception data, and the machine(s) 112 may localize itself better.

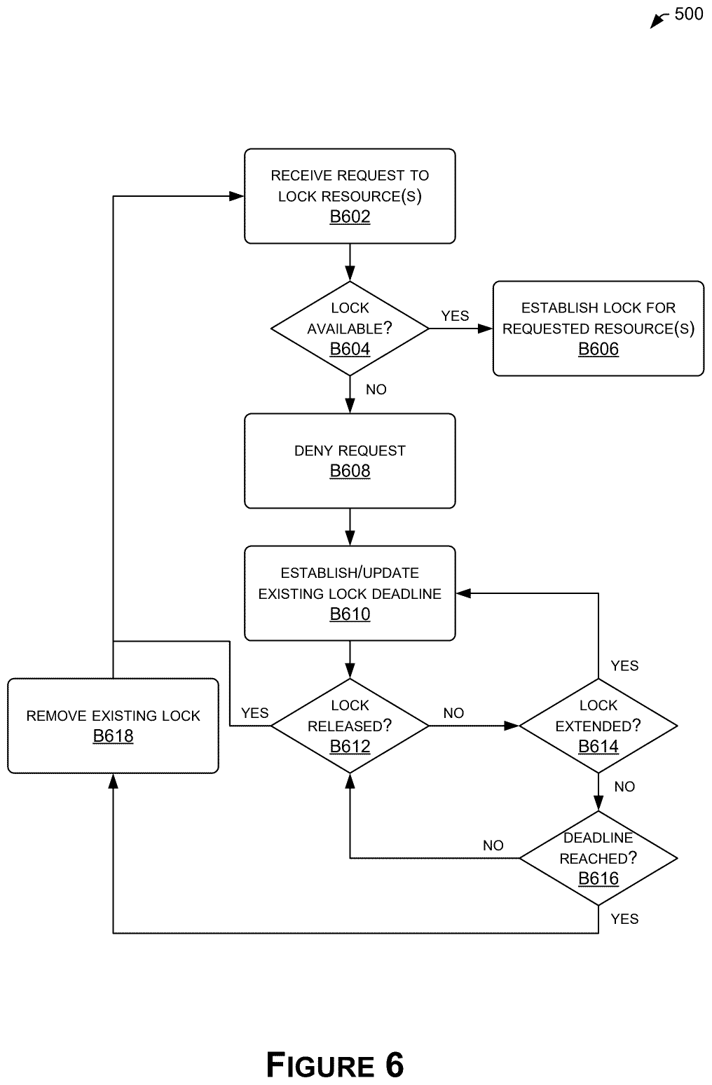

Now referring to FIGS. 6-9, each block of methods 600-900, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, methods 600-900 are described, by way of example, with respect to FIG. 1. However, these methods may additionally or alternatively be executed by any one system, or any combination of systems, including, but not limited to, those described herein.

FIG. 6 is a flow diagram illustrating an example method 600 for managing locks for exclusive access to shared resources, in accordance with some embodiments of the present disclosure. The method 600, at block B602, may include receiving a request to lock a resource(s). For instance, the access service 106 may receive the first request 104(1) from the first client 102(1) to update the resource(s). In some instances, the first request 104(1) may include a first geometric description corresponding to the resource(s).

The method 600, at block B604, may include determining whether a lock is available for the requested resource(s). For instance, the access service 106 may use the first geometric description included in the first request 104(1) to determine whether an existing lock is in place that overlaps the geometric description. In some examples, if it is determined at block B604 that the lock is available for the requested resource(s), the method 600 may proceed to block B606. However, if it is determined at block B604 that the lock is unavailable for the requested resource(s), the method 600 may proceed to block B608.

The method 600, at block B606, may include establishing the lock for the requested resource(s). For instance, the access service 106 may use the locking component 120 to establish the requested lock for the first client 102(1) to update the resource(s). The first client 102(1) may then proceed to update or apply an operation to the resource(s).

The method 600, at block B608, may include denying the request for the lock. For instance, the access service 106 may determine that at least a portion of the resource(s) are locked for updating and deny the requested lock. In some examples, the access service 106 may determine the resource(s) are locked based at least on a geometric description associated with the existing lock and the geometric descriptions submitted with the request.

The method 600, at block B610, may include establishing a deadline for the existing (e.g., active) lock. For instance, the scheduling component 118 of the access service 106 may establish the deadline (or timeout period) for the existing lock. In some examples, a time period for the deadline may be based on a variety of factors, including, but not limited to, a priority associated with the existing lock, a priority associated with the requested lock, the amount of resources locked with the existing lock, a number of requests for locks of the resource(s) (e.g., demand), or any other factors.

The method 600, at block B612, may include determining whether the existing lock has been released. For instance, the access service 106 may determine whether the existing lock has been voluntarily released (e.g., based on the update for the resource(s) being finished). Additionally, in some examples, determining whether the existing lock has been released may include determining whether the requested lock is available. In some examples, if it is determined at block B612 that the existing lock has been released, the method 600 may proceed to block B602 and restart the workflow. However, if it is determined at block B612 that the lock has not been released for the requested resource(s), the method 600 may proceed to block B614.

The method 600, at block B614, may include determining whether the existing lock has been extended. For instance, the access service 106 may determine whether the deadline has been extended. In some instances, the deadline may be extended based on activity associated with the existing lock (e.g., resource(s) are being updated actively and not stale) or based on a request to extend the deadline from the client. In some examples, if it is determined at block B614 that the existing lock has been extended, the method 600 may proceed to block B610 to update the deadline for the existing lock. However, if it is determined at block B614 that the lock has not been extended, the method 600 may proceed to block B616.

The method 600, at block B616, may include determining whether the deadline has been reached. For instance, the scheduling component 118 of the access service 106 may determine whether the deadline has been reached. In some instances, the deadline may be reached due to inactivity associated with the existing lock. For instance, the system holding the existing lock may be down, or the connection may be lost. In some examples, if it is determined at block B616 that the deadline has not been reached, the method 600 may proceed to block B612. However, if it is determined at block B616 that the deadline has been reached, the method 600 may proceed to block B618.

The method 600, at block B618, may include removing the existing lock. For instance, the existing lock may be force removed using the unlocking component 122 based on the deadline being reached. This may help avoid deadlocks to the resources and promote progress of updates. In some instances, when a lock is force removed, the resource(s) may be reverted to their most previous state prior to the lock.

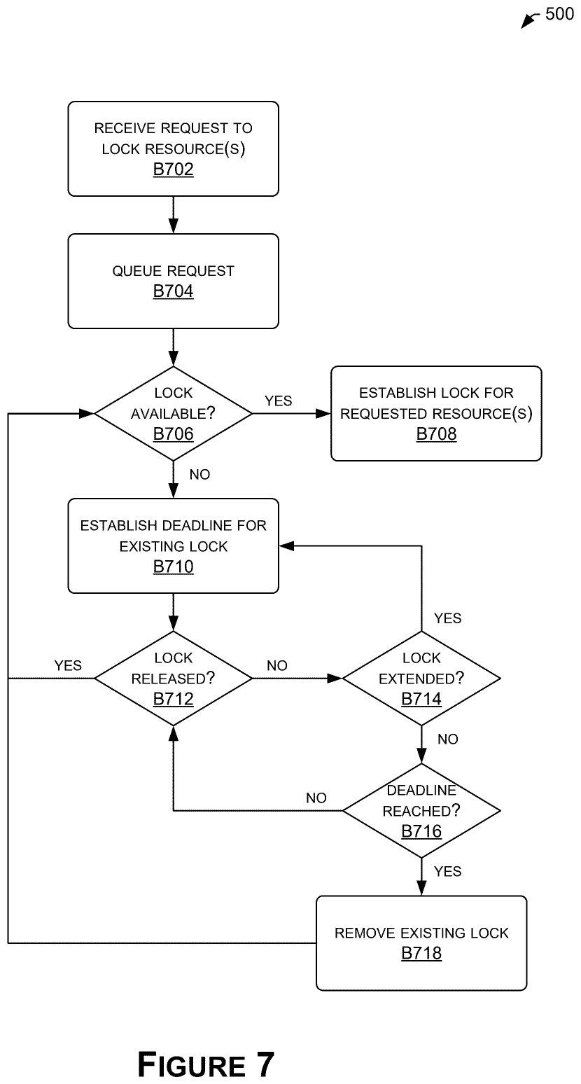

FIG. 7 is a flow diagram illustrating an example method 700 for managing locks for exclusive access to shared resources in a queue-enabled system, in accordance with some embodiments of the present disclosure. The method 700, at block B702, may include receiving a request to lock a resource(s). For instance, the access service 106 may receive the first request 104(1) from the first client 102(1) to update the resource(s). In some instances, the first request 104(1) may include a first geometric description corresponding to the resource(s).

The method 700, at block B704, may include queueing the request. For instance, the access service 106 may use the scheduling component 118 to implement a queue to maintain an order in which lock requests are submitted or received to promote work fairness. In such an example, request may be placed in the queue and a tracking identifier may be returned to the client that submitted the request.

The method 700, at block B706, may include determining whether a lock is available for the requested resource(s). For instance, the access service 106 may use the first geometric description included in the first request 104(1) to determine whether an existing lock is in place that overlaps the geometric description. In some examples, if it is determined at block B706 that the lock is available for the requested resource(s), the method 700 may proceed to block B708. However, if it is determined at block B706 that the lock is unavailable for the requested resource(s), the method 700 may proceed to block B710.

The method 700, at block B708, may include establishing the lock for the requested resource(s). For instance, the access service 106 may use the locking component 120 to establish the requested lock for the first client 102(1) to update the resource(s). The first client 102(1) may then proceed to update or apply an operation to the resource(s).

The method 700, at block B710, may include establishing a deadline for the existing (e.g., active) lock. For instance, the scheduling component 118 of the access service 106 may establish the deadline (or timeout period) for the existing lock. In some examples, a time period for the deadline may be based on a variety of factors, including, but not limited to, a priority associated with the existing lock, a priority associated with the requested lock, the amount of resources locked with the existing lock, a number of requests for locks of the resource(s) (e.g., demand), or any other factors.

The method 700, at block B712, may include determining whether the existing lock has been released. For instance, the access service 106 may determine whether the existing lock has been voluntarily released (e.g., based on the update for the resource(s) being finished). Additionally, in some examples, determining whether the existing lock has been released may include determining whether the requested lock is available. In some examples, if it is determined at block B712 that the existing lock has been released, the method 700 may proceed to block B706, where the queue may be updated and determine if the lock is available for the received request. However, if it is determined at block B712 that the lock has not been released, the method 700 may proceed to block B714.

The method 700, at block B714, may include determining whether the existing lock has been extended. For instance, the access service 106 may determine whether the deadline has been extended. In some instances, the deadline may be extended based on activity associated with the existing lock (e.g., resource(s) are being updated actively and not stale) or based on a request to extend the deadline from the client. In some examples, if it is determined at block B714 that the existing lock has been extended, the method 700 may proceed to block B710 to update the deadline for the existing lock. However, if it is determined at block B714 that the lock has not been extended, the method 700 may proceed to block B716.

The method 700, at block B716, may include determining whether the deadline has been reached. For instance, the scheduling component 118 of the access service 106 may determine whether the deadline has been reached. In some instances, the deadline may be reached due to inactivity associated with the existing lock. For instance, the system holding the existing lock may be down, or the connection may be lost. In some examples, if it is determined at block B716 that the deadline has not been reached, the method 700 may proceed to block B712. However, if it is determined at block B716 that the deadline has been reached, the method 700 may proceed to block B718.

The method 700, at block B718, may include removing the existing lock. For instance, the existing lock may be force removed using the unlocking component 122 based on the deadline being reached. This may help avoid deadlocks to the resources and promote progress of updates. In some instances, when a lock is force removed, the resource(s) may be reverted to their most previous state prior to the lock.

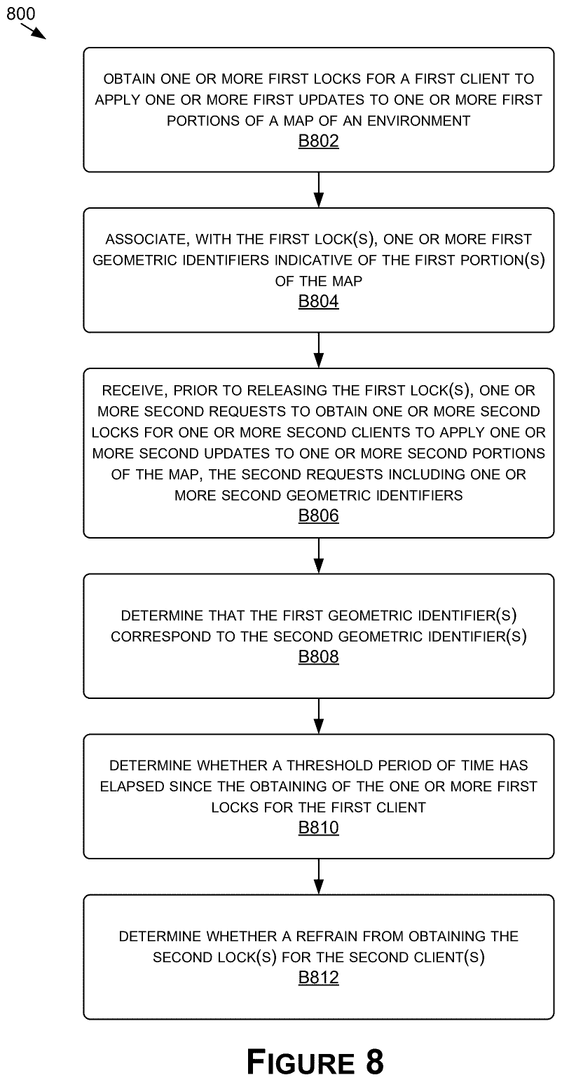

Referring now to FIG. 8, FIG. 8 is a flow diagram illustrating an example method 800 for geometric-based management of concurrent map updates, in accordance with some embodiments of the present disclosure. The method 800, at block B802, may include obtaining one or more first locks for a first client to apply one or more first updates to one or more first portions of a map of an environment. For instance, the access service 106 may use the locking component 120 to obtain the first lock(s) for the first client 102(1) to apply the first update(s) to the first portion(s) of the map of the environment.

The method 800, at block B804, may include associating, with the one or more first locks, one or more first geometric identifiers indicative of the one or more first portions of the map. For instance, the access service 106 may use the geometry component 116 to associate the first geometric identifier(s) with the first lock(s). As described herein, the geometric identifiers may be indicative of one or more portions (e.g., tiles, etc.) of a map and/or one or more geographic regions of an environment. In some examples, the first geometric identifier(s) may be included in an original request received from the first client to obtain the first lock(s).

The method 800, at block B806, may include receiving, prior to releasing the one or more first locks, one or more second requests to obtain one or more second locks for one or more second clients to apply one or more second updates to one or more second portions of the map, the one or more second requests including one or more second geometric identifiers. For instance, the access service 106 may receive, via the load balancer 108, the second request(s) (e.g., requests 104(2)-104(N)) to obtain the second lock(s). In some examples, the second request(s) may be received prior to a release of the first lock(s). The second request(s) may include the second geometric identifier(s) indicating one or more portions of the map or regions of the environment the second client(s) are requesting to lock.

The method 800, at block B808, may include determining that the first geometric identifier(s) correspond to the second geometric identifier(s). For instance, the access service 106 may determine, using the geometry component 116, that the first geometric identifier(s) correspond to the second geometric identifier(s). As an example, the geometry component 116 may determine based on the first and second geometric identifiers that the requested second locks overlap the first, active lock (e.g., that their underlying map resources or tiles overlap).

The method 800, at block B810, may include determining whether a threshold period of time has elapsed since the obtaining of the first lock(s) for the first client. For instance, the access service 106 may determine, using the scheduling component 118, whether the threshold period of time has elapsed since the obtaining of the first lock(s) for the first client. Additionally, or alternatively, the method 800 may include determining whether a threshold period of time has elapsed since a last operation submitted by the first client with respect to updating the map.

The method 800, at block B812, may include determining, based at least on the first geometric identifier(s) corresponding to the second geometric identifier(s) and whether the threshold period of time has elapsed, whether to refrain from obtaining the second lock(s) for the one or more second clients. For instance, the access service 106 may determine, using the geometry component 116 and/or the scheduling component 118, whether or not to refrain from obtaining the second lock(s). As an example, the geometry component 116 may determine based on the first and second geometric identifiers that the requested second locks overlap the first, active lock. Additionally, or alternatively, the scheduling component 118 may determine whether or not the threshold period of time has lapsed, and determine whether to refrain from obtaining the second lock(s) based on the period of time.

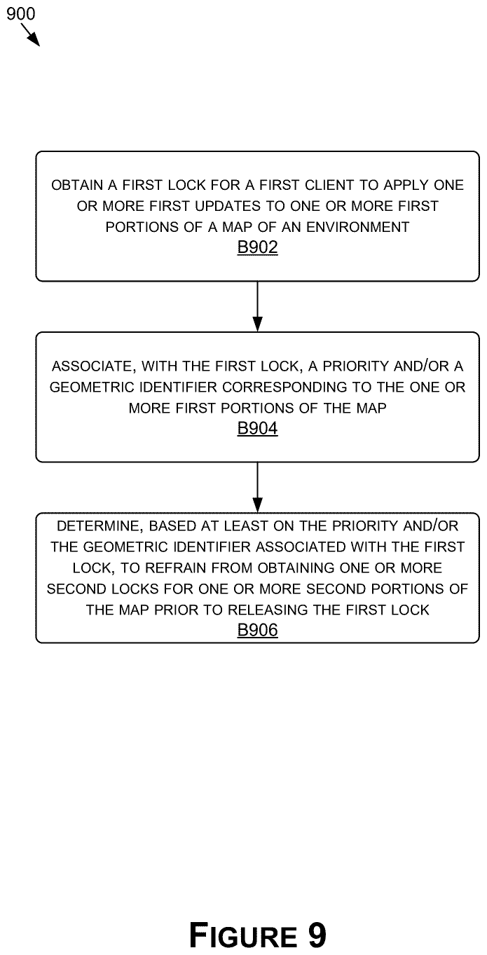

FIG. 9 is a flow diagram illustrating an example method 900 for enforcing causal ordering of concurrent map updates using geometric identifiers, in accordance with some embodiments of the present disclosure. The method 800, at block B802, may include obtaining a first lock for a first client to apply one or more first updates to one or more first portions of a map of an environment. For instance, the access service 106 may use the locking component 120 to obtain the first lock for the first client 102 to apply the first update(s) to the first portion(s) of the map of the environment.

The method 800, at block B804, may include associating, with the first lock, a priority and/or a geometric identifier corresponding to the one or more first portions of the map. For instance, the access service 106 may use the geometry component 116 to associate the geometric identifier with the first lock. As described herein, the geometric identifier may be indicative of one or more portions (e.g., tiles, etc.) of a map and/or one or more geographic regions of an environment. In some examples, the geometric identifier may be included in an original request received from the first client to obtain the first lock.

The method 800, at block B806, may include determining, based at least on the priority and/or the geometric identifier associated with the first lock, to refrain from obtaining, prior to releasing the first lock, one or more second locks for one or more second portions of the map that at least partially overlap the one or more first portions of the map. For instance, the access service 106 may determine, using the geometry component 116 and/or the scheduling component 118, to refrain from obtaining the second lock(s). As an example, the geometry component 116 may determine based on the geometric identifier that the requested second lock(s) overlap the first, active lock.

### Example Autonomous Vehicle

FIG. 10A is an illustration of an example autonomous vehicle 1000, in accordance with some embodiments of the present disclosure. The autonomous vehicle 1000 (alternatively referred to herein as the “vehicle 1000”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1000 may be capable of functionality in accordance with one or more of Level 3-Level 5 of the autonomous driving levels. The vehicle 1000 may be capable of functionality in accordance with one or more of Level 1-Level 5 of the autonomous driving levels. For example, the vehicle 1000 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1000 or other machine, such as being fully autonomous, being highly autonomous, being conditionally autonomous, being partially autonomous, providing assistive autonomy, being semi-autonomous, being primarily autonomous, or other designation.

The vehicle 1000 may include components such as a chassis, a vehicle body, wheels (e.g., 2, 4, 6, 8, 18, etc.), tires, axles, and other components of a vehicle. The vehicle 1000 may include a propulsion system 1050, such as an internal combustion engine, hybrid electric power plant, an all-electric engine, and/or another propulsion system type. The propulsion system 1050 may be connected to a drive train of the vehicle 1000, which may include a transmission, to enable the propulsion of the vehicle 1000. The propulsion system 1050 may be controlled in response to receiving signals from the throttle/accelerator 1052.

A steering system 1054, which may include a steering wheel, may be used to steer the vehicle 1000 (e.g., along a desired path or route) when the propulsion system 1050 is operating (e.g., when the vehicle is in motion). The steering system 1054 may receive signals from a steering actuator 1056. The steering wheel may be optional for full automation (Level 5) functionality.

The brake sensor system 1046 may be used to operate the vehicle brakes in response to receiving signals from the brake actuators 1048 and/or brake sensors.

Controller(s) 1036, which may include one or more system on chips (SoCs) 1004 (FIG. 10C) and/or GPU(s), may provide signals (e.g., representative of commands) to one or more components and/or systems of the vehicle 1000. For example, the controller(s) may send signals to operate the vehicle brakes via one or more brake actuators 1048, to operate the steering system 1054 via one or more steering actuators 1056, to operate the propulsion system 1050 via one or more throttle/accelerators 1052. The controller(s) 1036 may include one or more onboard (e.g., integrated) computing devices (e.g., supercomputers) that process sensor signals, and output operation commands (e.g., signals representing commands) to enable autonomous driving and/or to assist a human driver in driving the vehicle 1000. The controller(s) 1036 may include a first controller 1036 for autonomous driving functions, a second controller 1036 for functional safety functions, a third controller 1036 for artificial intelligence functionality (e.g., computer vision), a fourth controller 1036 for infotainment functionality, a fifth controller 1036 for redundancy in emergency conditions, and/or other controllers. In some examples, a single controller 1036 may handle two or more of the above functionalities, two or more controllers 1036 may handle a single functionality, and/or any combination thereof.

The controller(s) 1036 may provide the signals for controlling one or more components and/or systems of the vehicle 1000 in response to sensor data received from one or more sensors (e.g., sensor inputs). The sensor data may be received from, for example and without limitation, global navigation satellite systems (“GNSS”) sensor(s) 1058 (e.g., Global Positioning System sensor(s)), RADAR sensor(s) 1060, ultrasonic sensor(s) 1062, LIDAR sensor(s) 1064, inertial measurement unit (IMU) sensor(s) 1066 (e.g., accelerometer(s), gyroscope(s), magnetic compass (cs), magnetometer(s), etc.), microphone(s) 1096, stereo camera(s) 1068, wide-view camera(s) 1070 (e.g., fisheye cameras), infrared camera(s) 1072, surround camera(s) 1074 (e.g., 360 degree cameras), long-range and/or mid-range camera(s) 1098, speed sensor(s) 1044 (e.g., for measuring the speed of the vehicle 1000), vibration sensor(s) 1042, steering sensor(s) 1040, brake sensor(s) (e.g., as part of the brake sensor system 1046), and/or other sensor types.

One or more of the controller(s) 1036 may receive inputs (e.g., represented by input data) from an instrument cluster 1032 of the vehicle 1000 and provide outputs (e.g., represented by output data, display data, etc.) via a human-machine interface (HMI) display 1034, an audible annunciator, a loudspeaker, and/or via other components of the vehicle 1000. The outputs may include information such as vehicle velocity, speed, time, map data (e.g., the High Definition (“HD”) map 1022 of FIG. 10C), location data (e.g., the vehicle's 1000 location, such as on a map), direction, location of other vehicles (e.g., an occupancy grid), information about objects and status of objects as perceived by the controller(s) 1036, etc. For example, the HMI display 1034 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1000 further includes a network interface 1024 which may use one or more wireless antenna(s) 1026 and/or modem(s) to communicate over one or more networks. For example, the network interface 1024 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1026 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 10B is an example of camera locations and fields of view for the example autonomous vehicle 1000 of FIG. 10A, in accordance with some embodiments of the present disclosure. The cameras and respective fields of view are one example embodiment and are not intended to be limiting. For example, additional and/or alternative cameras may be included and/or the cameras may be located at different locations on the vehicle 1000.

The camera types for the cameras may include, but are not limited to, digital cameras that may be adapted for use with the components and/or systems of the vehicle 1000. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1000 (e.g., front-facing cameras) may be used for surround view, to help identify forward facing paths and obstacles, as well aid in, with the help of one or more controllers 1036 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1070 that may be used to perceive objects coming into view from the periphery (e.g., pedestrians, crossing traffic or bicycles). Although only one wide-view camera is illustrated in FIG. 10B, there may be any number (including zero) of wide-view cameras 1070 on the vehicle 1000. In addition, any number of long-range camera(s) 1098 (e.g., a long-view stereo camera pair) may be used for depth-based object detection, especially for objects for which a neural network has not yet been trained. The long-range camera(s) 1098 may also be used for object detection and classification, as well as basic object tracking.

Any number of stereo cameras 1068 may also be included in a front-facing configuration. In at least one embodiment, one or more of stereo camera(s) 1068 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1068 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1068 may be used in addition to, or alternatively from, those described herein.

Cameras with a field of view that include portions of the environment to the side of the vehicle 1000 (e.g., side-view cameras) may be used for surround view, providing information used to create and update the occupancy grid, as well as to generate side impact collision warnings. For example, surround camera(s) 1074 (e.g., four surround cameras 1074 as illustrated in FIG. 10B) may be positioned to on the vehicle 1000. The surround camera(s) 1074 may include wide-view camera(s) 1070, fisheye camera(s), 360 degree camera(s), and/or the like. Four example, four fisheye cameras may be positioned on the vehicle's front, rear, and sides. In an alternative arrangement, the vehicle may use three surround camera(s) 1074 (e.g., left, right, and rear), and may leverage one or more other camera(s) (e.g., a forward-facing camera) as a fourth surround view camera.

Cameras with a field of view that include portions of the environment to the rear of the vehicle 1000 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1098, stereo camera(s) 1068), infrared camera(s) 1072, etc.), as described herein.

FIG. 10C is a block diagram of an example system architecture for the example autonomous vehicle 1000 of FIG. 10A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1000 in FIG. 10C are illustrated as being connected via bus 1002. The bus 1002 may include a Controller Area Network (CAN) data interface (alternatively referred to herein as a “CAN bus”). A CAN may be a network inside the vehicle 1000 used to aid in control of various features and functionality of the vehicle 1000, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1002 is described herein as being a CAN bus, this is not intended to be limiting. For example, in addition to, or alternatively from, the CAN bus, FlexRay and/or Ethernet may be used. Additionally, although a single line is used to represent the bus 1002, this is not intended to be limiting. For example, there may be any number of busses 1002, which may include one or more CAN busses, one or more FlexRay busses, one or more Ethernet busses, and/or one or more other types of busses using a different protocol. In some examples, two or more busses 1002 may be used to perform different functions, and/or may be used for redundancy. For example, a first bus 1002 may be used for collision avoidance functionality and a second bus 1002 may be used for actuation control. In any example, each bus 1002 may communicate with any of the components of the vehicle 1000, and two or more busses 1002 may communicate with the same components. In some examples, each SoC 1004, each controller 1036, and/or each computer within the vehicle may have access to the same input data (e.g., inputs from sensors of the vehicle 1000), and may be connected to a common bus, such the CAN bus.

The vehicle 1000 may include one or more controller(s) 1036, such as those described herein with respect to FIG. 10A. The controller(s) 1036 may be used for a variety of functions. The controller(s) 1036 may be coupled to any of the various other components and systems of the vehicle 1000, and may be used for control of the vehicle 1000, artificial intelligence of the vehicle 1000, infotainment for the vehicle 1000, and/or the like.

The vehicle 1000 may include a system(s) on a chip (SoC) 1004. The SoC 1004 may include CPU(s) 1006, GPU(s) 1008, processor(s) 1010, cache(s) 1012, accelerator(s) 1014, data store(s) 1016, and/or other components and features not illustrated. The SoC(s) 1004 may be used to control the vehicle 1000 in a variety of platforms and systems. For example, the SoC(s) 1004 may be combined in a system (e.g., the system of the vehicle 1000) with an HD map 1022 which may obtain map refreshes and/or updates via a network interface 1024 from one or more servers (e.g., server(s) 1078 of FIG. 10D).

The CPU(s) 1006 may include a CPU cluster or CPU complex (alternatively referred to herein as a “CCPLEX”). The CPU(s) 1006 may include multiple cores and/or L2 caches. For example, in some embodiments, the CPU(s) 1006 may include eight cores in a coherent multi-processor configuration. In some embodiments, the CPU(s) 1006 may include four dual-core clusters where each cluster has a dedicated L2 cache (e.g., a 2 MB L2 cache). The CPU(s) 1006 (e.g., the CCPLEX) may be configured to support simultaneous cluster operation enabling any combination of the clusters of the CPU(s) 1006 to be active at any given time.

The CPU(s) 1006 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1006 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1008 may include an integrated GPU (alternatively referred to herein as an “iGPU”). The GPU(s) 1008 may be programmable and may be efficient for parallel workloads. The GPU(s) 1008, in some examples, may use an enhanced tensor instruction set. The GPU(s) 1008 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1008 may include at least eight streaming microprocessors. The GPU(s) 1008 may use compute application programming interface(s) (API(s)). In addition, the GPU(s) 1008 may use one or more parallel computing platforms and/or programming models (e.g., NVIDIA's CUDA).

The GPU(s) 1008 may be power-optimized for best performance in automotive and embedded use cases. For example, the GPU(s) 1008 may be fabricated on a Fin field-effect transistor (FinFET). However, this is not intended to be limiting and the GPU(s) 1008 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an LO instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined LI data cache and shared memory unit in order to improve performance while simplifying programming.

The GPU(s) 1008 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1008 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1008 to access the CPU(s) 1006 page tables directly. In such examples, when the GPU(s) 1008 memory management unit (MMU) experiences a miss, an address translation request may be transmitted to the CPU(s) 1006. In response, the CPU(s) 1006 may look in its page tables for the virtual-to-physical mapping for the address and transmits the translation back to the GPU(s) 1008. As such, unified memory technology may allow a single unified virtual address space for memory of both the CPU(s) 1006 and the GPU(s) 1008, thereby simplifying the GPU(s) 1008 programming and porting of applications to the GPU(s) 1008.

In addition, the GPU(s) 1008 may include an access counter that may keep track of the frequency of access of the GPU(s) 1008 to memory of other processors. The access counter may help ensure that memory pages are moved to the physical memory of the processor that is accessing the pages most frequently.

The SoC(s) 1004 may include any number of cache(s) 1012, including those described herein. For example, the cache(s) 1012 may include an L3 cache that is available to both the CPU(s) 1006 and the GPU(s) 1008 (e.g., that is connected both the CPU(s) 1006 and the GPU(s) 1008). The cache(s) 1012 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1004 may include an arithmetic logic unit(s) (ALU(s)) which may be leveraged in performing processing with respect to any of the variety of tasks or operations of the vehicle 1000—such as processing DNNs. In addition, the SoC(s) 1004 may include a floating point unit(s) (FPU(s))—or other math coprocessor or numeric coprocessor types—for performing mathematical operations within the system. For example, the SoC(s) 1004 may include one or more FPUs integrated as execution units within a CPU(s) 1006 and/or GPU(s) 1008.

The SoC(s) 1004 may include one or more accelerators 1014 (e.g., hardware accelerators, software accelerators, or a combination thereof). For example, the SoC(s) 1004 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 1008 and to off-load some of the tasks of the GPU(s) 1008 (e.g., to free up more cycles of the GPU(s) 1008 for performing other tasks). As an example, the accelerator(s) 1014 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1014 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1008, and by using an inference accelerator, for example, a designer may target either the DLA(s) or the GPU(s) 1008 for any function. For example, the designer may focus processing of CNNs and floating point operations on the DLA(s) and leave other functions to the GPU(s) 1008 and/or other accelerator(s) 1014.

The accelerator(s) 1014 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 1006. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1014 (e.g., the hardware acceleration cluster) may include a computer vision network on-chip and SRAM, for providing a high-bandwidth, low latency SRAM for the accelerator(s) 1014. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1004 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 1014 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1066 output that correlates with the vehicle 1000 orientation, distance, 3D location estimates of the object obtained from the neural network and/or other sensors (e.g., LIDAR sensor(s) 1064 or RADAR sensor(s) 1060), among others.

The SoC(s) 1004 may include data store(s) 1016 (e.g., memory). The data store(s) 1016 may be on-chip memory of the SoC(s) 1004, which may store neural networks to be executed on the GPU and/or the DLA. In some examples, the data store(s) 1016 may be large enough in capacity to store multiple instances of neural networks for redundancy and safety. The data store(s) 1012 may comprise L2 or L3 cache(s) 1012. Reference to the data store(s) 1016 may include reference to the memory associated with the PVA, DLA, and/or other accelerator(s) 1014, as described herein.

The SoC(s) 1004 may include one or more processor(s) 1010 (e.g., embedded processors). The processor(s) 1010 may include a boot and power management processor that may be a dedicated processor and subsystem to handle boot power and management functions and related security enforcement. The boot and power management processor may be a part of the SoC(s) 1004 boot sequence and may provide runtime power management services. The boot power and management processor may provide clock and voltage programming, assistance in system low power state transitions, management of SoC(s) 1004 thermals and temperature sensors, and/or management of the SoC(s) 1004 power states. Each temperature sensor may be implemented as a ring-oscillator whose output frequency is proportional to temperature, and the SoC(s) 1004 may use the ring-oscillators to detect temperatures of the CPU(s) 1006, GPU(s) 1008, and/or accelerator(s) 1014. If temperatures are determined to exceed a threshold, the boot and power management processor may enter a temperature fault routine and put the SoC(s) 1004 into a lower power state and/or put the vehicle 1000 into a chauffeur to safe stop mode (e.g., bring the vehicle 1000 to a safe stop).

The processor(s) 1010 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1010 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1010 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1010 may further include a real-time camera engine that may include a dedicated processor subsystem for handling real-time camera management.

The processor(s) 1010 may further include a high-dynamic range signal processor that may include an image signal processor that is a hardware engine that is part of the camera processing pipeline.

The processor(s) 1010 may include a video image compositor that may be a processing block (e.g., implemented on a microprocessor) that implements video post-processing functions needed by a video playback application to produce the final image for the player window. The video image compositor may perform lens distortion correction on wide-view camera(s) 1070, surround camera(s) 1074, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1008 is not required to continuously render new surfaces. Even when the GPU(s) 1008 is powered on and active doing 3D rendering, the video image compositor may be used to offload the GPU(s) 1008 to improve performance and responsiveness.

The SoC(s) 1004 may further include a mobile industry processor interface (MIPI) camera serial interface for receiving video and input from cameras, a high-speed interface, and/or a video input block that may be used for camera and related pixel input functions. The SoC(s) 1004 may further include an input/output controller(s) that may be controlled by software and may be used for receiving I/O signals that are uncommitted to a specific role.

The SoC(s) 1004 may further include a broad range of peripheral interfaces to enable communication with peripherals, audio codecs, power management, and/or other devices. The SoC(s) 1004 may be used to process data from cameras (e.g., connected over Gigabit Multimedia Serial Link and Ethernet), sensors (e.g., LIDAR sensor(s) 1064, RADAR sensor(s) 1060, etc. that may be connected over Ethernet), data from bus 1002 (e.g., speed of vehicle 1000, steering wheel position, etc.), data from GNSS sensor(s) 1058 (e.g., connected over Ethernet or CAN bus). The SoC(s) 1004 may further include dedicated high-performance mass storage controllers that may include their own DMA engines, and that may be used to free the CPU(s) 1006 from routine data management tasks.

The SoC(s) 1004 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1004 may be faster, more reliable, and even more energy-efficient and space-efficient than conventional systems. For example, the accelerator(s) 1014, when combined with the CPU(s) 1006, the GPU(s) 1008, and the data store(s) 1016, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 1020) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1008.

In some examples, a CNN for facial recognition and vehicle owner identification may use data from camera sensors to identify the presence of an authorized driver and/or owner of the vehicle 1000. The always on sensor processing engine may be used to unlock the vehicle when the owner approaches the driver door and turn on the lights, and, in security mode, to disable the vehicle when the owner leaves the vehicle. In this way, the SoC(s) 1004 provide for security against theft and/or carjacking.

In another example, a CNN for emergency vehicle detection and identification may use data from microphones 1096 to detect and identify emergency vehicle sirens. In contrast to conventional systems, that use general classifiers to detect sirens and manually extract features, the SoC(s) 1004 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1058. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1062, until the emergency vehicle(s) passes.

The vehicle may include a CPU(s) 1018 (e.g., discrete CPU(s), or dCPU(s)), that may be coupled to the SoC(s) 1004 via a high-speed interconnect (e.g., PCIe). The CPU(s) 1018 may include an X86 processor, for example. The CPU(s) 1018 may be used to perform any of a variety of functions, including arbitrating potentially inconsistent results between ADAS sensors and the SoC(s) 1004, and/or monitoring the status and health of the controller(s) 1036 and/or infotainment SoC 1030, for example.

The vehicle 1000 may include a GPU(s) 1020 (e.g., discrete GPU(s), or dGPU(s)), that may be coupled to the SoC(s) 1004 via a high-speed interconnect (e.g., NVIDIA's NVLINK). The GPU(s) 1020 may provide additional artificial intelligence functionality, such as by executing redundant and/or different neural networks, and may be used to train and/or update neural networks based on input (e.g., sensor data) from sensors of the vehicle 1000.

The vehicle 1000 may further include the network interface 1024 which may include one or more wireless antennas 1026 (e.g., one or more wireless antennas for different communication protocols, such as a cellular antenna, a Bluetooth antenna, etc.). The network interface 1024 may be used to enable wireless connectivity over the Internet with the cloud (e.g., with the server(s) 1078 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1000 information about vehicles in proximity to the vehicle 1000 (e.g., vehicles in front of, on the side of, and/or behind the vehicle 1000). This functionality may be part of a cooperative adaptive cruise control functionality of the vehicle 1000.

The network interface 1024 may include a SoC that provides modulation and demodulation functionality and enables the controller(s) 1036 to communicate over wireless networks. The network interface 1024 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1000 may further include data store(s) 1028 which may include off-chip (e.g., off the SoC(s) 1004) storage. The data store(s) 1028 may include one or more storage elements including RAM, SRAM, DRAM, VRAM, Flash, hard disks, and/or other components and/or devices that may store at least one bit of data.

The vehicle 1000 may further include GNSS sensor(s) 1058. The GNSS sensor(s) 1058 (e.g., GPS, assisted GPS sensors, differential GPS (DGPS) sensors, etc.), to assist in mapping, perception, occupancy grid generation, and/or path planning functions. Any number of GNSS sensor(s) 1058 may be used, including, for example and without limitation, a GPS using a USB connector with an Ethernet to Serial (RS-232) bridge.

The vehicle 1000 may further include RADAR sensor(s) 1060. The RADAR sensor(s) 1060 may be used by the vehicle 1000 for long-range vehicle detection, even in darkness and/or severe weather conditions. RADAR functional safety levels may be ASIL B. The RADAR sensor(s) 1060 may use the CAN and/or the bus 1002 (e.g., to transmit data generated by the RADAR sensor(s) 1060) for control and to access object tracking data, with access to Ethernet to access raw data in some examples. A wide variety of RADAR sensor types may be used. For example, and without limitation, the RADAR sensor(s) 1060 may be suitable for front, rear, and side RADAR use. In some example, Pulse Doppler RADAR sensor(s) are used.

The RADAR sensor(s) 1060 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1060 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1000 surroundings at higher speeds with minimal interference from traffic in adjacent lanes. The other two antennae may expand the field of view, making it possible to quickly detect vehicles entering or leaving the vehicle's 1000 lane.

Mid-range RADAR systems may include, as an example, a range of up to 1060 m (front) or 80 m (rear), and a field of view of up to 42 degrees (front) or 1050 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1000 may further include ultrasonic sensor(s) 1062. The ultrasonic sensor(s) 1062, which may be positioned at the front, back, and/or the sides of the vehicle 1000, may be used for park assist and/or to create and update an occupancy grid. A wide variety of ultrasonic sensor(s) 1062 may be used, and different ultrasonic sensor(s) 1062 may be used for different ranges of detection (e.g., 2.5 m, 4 m). The ultrasonic sensor(s) 1062 may operate at functional safety levels of ASIL B.

The vehicle 1000 may include LIDAR sensor(s) 1064. The LIDAR sensor(s) 1064 may be used for object and pedestrian detection, emergency braking, collision avoidance, and/or other functions. The LIDAR sensor(s) 1064 may be functional safety level ASIL B. In some examples, the vehicle 1000 may include multiple LIDAR sensors 1064 (e.g., two, four, six, etc.) that may use Ethernet (e.g., to provide data to a Gigabit Ethernet switch).

In some examples, the LIDAR sensor(s) 1064 may be capable of providing a list of objects and their distances for a 360-degree field of view. Commercially available LIDAR sensor(s) 1064 may have an advertised range of approximately 1000 m, with an accuracy of 2 cm-3 cm, and with support for a 1000 Mbps Ethernet connection, for example. In some examples, one or more non-protruding LIDAR sensors 1064 may be used. In such examples, the LIDAR sensor(s) 1064 may be implemented as a small device that may be embedded into the front, rear, sides, and/or corners of the vehicle 1000. The LIDAR sensor(s) 1064, in such examples, may provide up to a 120-degree horizontal and 35-degree vertical field-of-view, with a 200 m range even for low-reflectivity objects. Front-mounted LIDAR sensor(s) 1064 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 1000. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 1064 may be less susceptible to motion blur, vibration, and/or shock.

The vehicle may further include IMU sensor(s) 1066. The IMU sensor(s) 1066 may be located at a center of the rear axle of the vehicle 1000, in some examples. The IMU sensor(s) 1066 may include, for example and without limitation, an accelerometer(s), a magnetometer(s), a gyroscope(s), a magnetic compass(es), and/or other sensor types. In some examples, such as in six-axis applications, the IMU sensor(s) 1066 may include accelerometers and gyroscopes, while in nine-axis applications, the IMU sensor(s) 1066 may include accelerometers, gyroscopes, and magnetometers.

In some embodiments, the IMU sensor(s) 1066 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1066 may enable the vehicle 1000 to estimate heading without requiring input from a magnetic sensor by directly observing and correlating the changes in velocity from GPS to the IMU sensor(s) 1066. In some examples, the IMU sensor(s) 1066 and the GNSS sensor(s) 1058 may be combined in a single integrated unit.

The vehicle may include microphone(s) 1096 placed in and/or around the vehicle 1000. The microphone(s) 1096 may be used for emergency vehicle detection and identification, among other things.

The vehicle may further include any number of camera types, including stereo camera(s) 1068, wide-view camera(s) 1070, infrared camera(s) 1072, surround camera(s) 1074, long-range and/or mid-range camera(s) 1098, and/or other camera types. The cameras may be used to capture image data around an entire periphery of the vehicle 1000. The types of cameras used depends on the embodiments and requirements for the vehicle 1000, and any combination of camera types may be used to provide the necessary coverage around the vehicle 1000. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 10A and FIG. 10B.

The vehicle 1000 may further include vibration sensor(s) 1042. The vibration sensor(s) 1042 may measure vibrations of components of the vehicle, such as the axle(s). For example, changes in vibrations may indicate a change in road surfaces. In another example, when two or more vibration sensors 1042 are used, the differences between the vibrations may be used to determine friction or slippage of the road surface (e.g., when the difference in vibration is between a power-driven axle and a freely rotating axle).

The vehicle 1000 may include an ADAS system 1038. The ADAS system 1038 may include a SoC, in some examples. The ADAS system 1038 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1060, LIDAR sensor(s) 1064, and/or a camera(s). The ACC systems may include longitudinal ACC and/or lateral ACC. Longitudinal ACC monitors and controls the distance to the vehicle immediately ahead of the vehicle 1000 and automatically adjust the vehicle speed to maintain a safe distance from vehicles ahead. Lateral ACC performs distance keeping, and advises the vehicle 1000 to change lanes when necessary. Lateral ACC is related to other ADAS applications such as LCA and CWS.

CACC uses information from other vehicles that may be received via the network interface 1024 and/or the wireless antenna(s) 1026 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1000), while the I2V communication concept provides information about traffic further ahead. CACC systems may include either or both I2V and V2V information sources. Given the information of the vehicles ahead of the vehicle 1000, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1060, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1060, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1000 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1000 if the vehicle 1000 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1060, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1000 is backing up. Some RCTW systems include AEB to ensure that the vehicle brakes are applied to avoid a crash. RCTW systems may use one or more rear-facing RADAR sensor(s) 1060, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1000, the vehicle 1000 itself must, in the case of conflicting results, decide whether to heed the result from a primary computer or a secondary computer (e.g., a first controller 1036 or a second controller 1036). For example, in some embodiments, the ADAS system 1038 may be a backup and/or secondary computer for providing perception information to a backup computer rationality module. The backup computer rationality monitor may run a redundant diverse software on hardware components to detect faults in perception and dynamic driving tasks. Outputs from the ADAS system 1038 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1004.

In other examples, ADAS system 1038 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1038 may be fed into the primary computer's perception block and/or the primary computer's dynamic driving task block. For example, if the ADAS system 1038 indicates a forward crash warning due to an object immediately ahead, the perception block may use this information when identifying objects. In other examples, the secondary computer may have its own neural network which is trained and thus reduces the risk of false positives, as described herein.

The vehicle 1000 may further include the infotainment SoC 1030 (e.g., an in-vehicle infotainment system (IVI)). Although illustrated and described as a SoC, the infotainment system may not be a SoC, and may include two or more discrete components. The infotainment SoC 1030 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1000. For example, the infotainment SoC 1030 may radios, disk players, navigation systems, video players, USB and Bluetooth connectivity, carputers, in-car entertainment, Wi-Fi, steering wheel audio controls, hands free voice control, a heads-up display (HUD), an HMI display 1034, a telematics device, a control panel (e.g., for controlling and/or interacting with various components, features, and/or systems), and/or other components. The infotainment SoC 1030 may further be used to provide information (e.g., visual and/or audible) to a user(s) of the vehicle, such as information from the ADAS system 1038, autonomous driving information such as planned vehicle maneuvers, trajectories, surrounding environment information (e.g., intersection information, vehicle information, road information, etc.), and/or other information.

The infotainment SoC 1030 may include GPU functionality. The infotainment SoC 1030 may communicate over the bus 1002 (e.g., CAN bus, Ethernet, etc.) with other devices, systems, and/or components of the vehicle 1000. In some examples, the infotainment SoC 1030 may be coupled to a supervisory MCU such that the GPU of the infotainment system may perform some self-driving functions in the event that the primary controller(s) 1036 (e.g., the primary and/or backup computers of the vehicle 1000) fail. In such an example, the infotainment SoC 1030 may put the vehicle 1000 into a chauffeur to safe stop mode, as described herein.

The vehicle 1000 may further include an instrument cluster 1032 (e.g., a digital dash, an electronic instrument cluster, a digital instrument panel, etc.). The instrument cluster 1032 may include a controller and/or supercomputer (e.g., a discrete controller or supercomputer). The instrument cluster 1032 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1030 and the instrument cluster 1032. In other words, the instrument cluster 1032 may be included as part of the infotainment SoC 1030, or vice versa.

FIG. 10D is a system diagram for communication between cloud-based server(s) and the example autonomous vehicle 1000 of FIG. 10A, in accordance with some embodiments of the present disclosure. The system 1076 may include server(s) 1078, network(s) 1090, and vehicles, including the vehicle 1000. The server(s) 1078 may include a plurality of GPUs 1084(A)-1084(H) (collectively referred to herein as GPUs 1084), PCIe switches 1082(A)-1082(H) (collectively referred to herein as PCIe switches 1082), and/or CPUs 1080(A)-1080(B) (collectively referred to herein as CPUs 1080). The GPUs 1084, the CPUs 1080, and the PCIe switches may be interconnected with high-speed interconnects such as, for example and without limitation, NVLink interfaces 1088 developed by NVIDIA and/or PCIe connections 1086. In some examples, the GPUs 1084 are connected via NVLink and/or NVSwitch SoC and the GPUs 1084 and the PCIe switches 1082 are connected via PCIe interconnects. Although eight GPUs 1084, two CPUs 1080, and two PCIe switches are illustrated, this is not intended to be limiting. Depending on the embodiment, each of the server(s) 1078 may include any number of GPUs 1084, CPUs 1080, and/or PCIe switches. For example, the server(s) 1078 may each include eight, sixteen, thirty-two, and/or more GPUs 1084.

The server(s) 1078 may receive, over the network(s) 1090 and from the vehicles, image data representative of images showing unexpected or changed road conditions, such as recently commenced road-work. The server(s) 1078 may transmit, over the network(s) 1090 and to the vehicles, neural networks 1092, updated neural networks 1092, and/or map information 1094, including information regarding traffic and road conditions. The updates to the map information 1094 may include updates for the HD map 1022, such as information regarding construction sites, potholes, detours, flooding, and/or other obstructions. In some examples, the neural networks 1092, the updated neural networks 1092, and/or the map information 1094 may have resulted from new training and/or experiences represented in data received from any number of vehicles in the environment, and/or based on training performed at a datacenter (e.g., using the server(s) 1078 and/or other servers).

The server(s) 1078 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1090, and/or the machine learning models may be used by the server(s) 1078 to remotely monitor the vehicles.

In some examples, the server(s) 1078 may receive data from the vehicles and apply the data to up-to-date real-time neural networks for real-time intelligent inferencing. The server(s) 1078 may include deep-learning supercomputers and/or dedicated Al computers powered by GPU(s) 1084, such as a DGX and DGX Station machines developed by NVIDIA. However, in some examples, the server(s) 1078 may include deep learning infrastructure that use only CPU-powered datacenters.

The deep-learning infrastructure of the server(s) 1078 may be capable of fast, real-time inferencing, and may use that capability to evaluate and verify the health of the processors, software, and/or associated hardware in the vehicle 1000. For example, the deep-learning infrastructure may receive periodic updates from the vehicle 1000, such as a sequence of images and/or objects that the vehicle 1000 has located in that sequence of images (e.g., via computer vision and/or other machine learning object classification techniques). The deep-learning infrastructure may run its own neural network to identify the objects and compare them with the objects identified by the vehicle 1000 and, if the results do not match and the infrastructure concludes that the AI in the vehicle 1000 is malfunctioning, the server(s) 1078 may transmit a signal to the vehicle 1000 instructing a fail-safe computer of the vehicle 1000 to assume control, notify the passengers, and complete a safe parking maneuver.

For inferencing, the server(s) 1078 may include the GPU(s) 1084 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). In other words, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that enable the computing device 1100 to communicate with other computing devices via an electronic communication network, included wired and/or wireless communications. The communication interface 1110 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may enable the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that enable detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to enable the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

### Example Data Center

FIG. 12 illustrates an example data center 1200 that may be used in at least one embodiments of the present disclosure. The data center 1200 may include a data center infrastructure layer 1210, a framework layer 1220, a software layer 1230, and/or an application layer 1240.

As shown in FIG. 12, the data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1216(1)-1216(N) may correspond to a server having one or more of the above-mentioned computing resources. In addition, in some embodiments, the node C.R.s 1216(1)-12161(N) may include one or more virtual components, such as vGPUs, vCPUs, and/or the like, and/or one or more of the node C.R.s 1216(1)-1216(N) may correspond to a virtual machine (VM).

In at least one embodiment, grouped computing resources 1214 may include separate groupings of node C.R.s 1216 housed within one or more racks (not shown), or many racks housed in data centers at various geographical locations (also not shown). Separate groupings of node C.R.s 1216 within grouped computing resources 1214 may include grouped compute, network, memory or storage resources that may be configured or allocated to support one or more workloads. In at least one embodiment, several node C.R.s 1216 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1212 may configure or otherwise control one or more node C.R.s 1216(1)-1216(N) and/or grouped computing resources 1214. In at least one embodiment, resource orchestrator 1212 may include a software design infrastructure (SDI) management entity for the data center 1200. The resource orchestrator 1212 may include hardware, software, or some combination thereof.

In at least one embodiment, as shown in FIG. 12, framework layer 1220 may include a job scheduler 1233, a configuration manager 1234, a resource manager 1236, and/or a distributed file system 1238. The framework layer 1220 may include a framework to support software 1232 of software layer 1230 and/or one or more application(s) 1242 of application layer 1240. The software 1232 or application(s) 1242 may respectively include web-based service software or applications, such as those provided by Amazon Web Services, Google Cloud and Microsoft Azure. The framework layer 1220 may be, but is not limited to, a type of free and open-source software web application framework such as Apache SparkTM (hereinafter “Spark”) that may utilize distributed file system 1238 for large-scale data processing (e.g., “big data”). In at least one embodiment, job scheduler 1233 may include a Spark driver to facilitate scheduling of workloads supported by various layers of data center 1200. The configuration manager 1234 may be capable of configuring different layers such as software layer 1230 and framework layer 1220 including Spark and distributed file system 1238 for supporting large-scale data processing. The resource manager 1236 may be capable of managing clustered or grouped computing resources mapped to or allocated for support of distributed file system 1238 and job scheduler 1233. In at least one embodiment, clustered or grouped computing resources may include grouped computing resource 1214 at data center infrastructure layer 1210. The resource manager 1236 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1238 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1234, resource manager 1236, and resource orchestrator 1212 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

The data center 1200 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1200. In at least one embodiment, trained or deployed machine learning models corresponding to one or more neural networks may be used to infer or predict information using resources described above with respect to the data center 1200 by using weight parameters calculated through one or more training techniques, such as but not limited to those described herein.

In at least one embodiment, the data center 1200 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center 1200, an example of which is described in more detail herein with respect to FIG. 12.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and clement B, clement A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example System

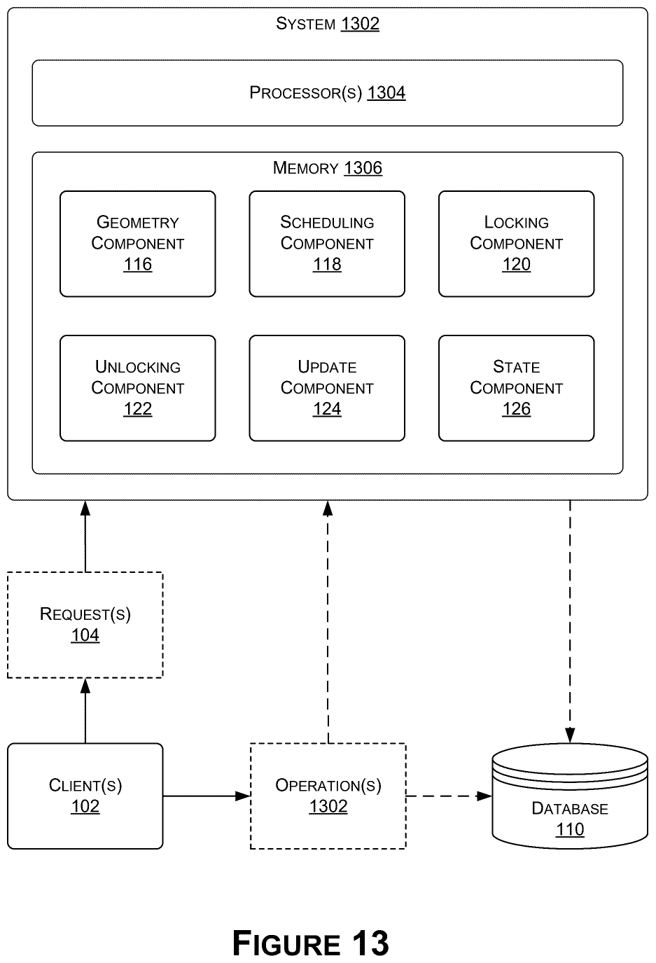

FIG. 13 illustrates an example of a system 1302 that may perform one or more of the processes described herein, in accordance with some embodiments of the present disclosure. As shown, the system 1302 (which may represent, and/or include, the example computing device(s) 1100 and/or the example data center 1200) may include one or more processors 1304 (which may be similar to, and/or include, the CPUs 1106 and/or the GPUs 1108) and memory 1306 (which may be similar to, and/or include, the memory 1104). For instance, the memory 1306 may store the geometry component 116, the scheduling component 118, the locking component 120, the unlocking component 122, the updating component 124, and/or the state component 126. Additionally, the processor(s) 1304 may execute the geometry component 116, the scheduling component 118, the locking component 120, the unlocking component 122, the updating component 124, and/or the state component 126 to perform one or more of the processes described herein.

Additionally, as shown by the example of FIG. 13, the system 1300 may receive the request(s) 104 from the client(s) 102 (which may also be similar to, and/or include, the example computing device 1100 and/or the example data center 1200) to lock resources (e.g., map tiles) of the database 110. The system 1300 may lock the requested resources and the client(s) 102 may apply one or more operations 1302 to the locked resources of the database 110. In some examples, the operation(s) 1302 may be routed through the system 1300 and/or directly between the client(s) 102 and the database 110.

### EXAMPLE PARAGRAPHS

A. A method comprising: obtaining one or more first locks for a first client to apply one or more first updates to one or more first portions of a map of an environment; associating, with the one or more first locks, one or more first geometric identifiers indicative of the one or more first portions of the map; receiving, prior to releasing the one or more first locks, one or more second requests to obtain one or more second locks for one or more second clients to apply one or more second updates to one or more second portions of the map, the one or more second requests including one or more second geometric identifiers; determining that the one or more first geometric identifiers correspond to the one or more second geometric identifiers; determining whether a threshold period of time has elapsed since the obtaining of the one or more first locks for the first client; and determining, based at least on the one or more first geometric identifiers corresponding to the one or more second geometric identifiers and whether the threshold period of time has elapsed, whether to refrain from obtaining the one or more second locks for the one or more second clients.

B. The method of claim 1, further comprising: receiving, prior to releasing the one or more first locks, one or more third requests to obtain one or more third locks for one or more third portions of the map that at least partially overlap the one or more first portions; releasing the one or more first locks based at least on one or more lock priorities indicated in the one or more third requests; and obtaining the one or more third locks for the one or more third portions of the map subsequent to the releasing.

C. The method of claim 1, wherein: the one or more first locks comprise one or more first mutual exclusions (mutexes) corresponding to the one or more first portions of the map, the one or more second locks comprise one or more second mutexes corresponding to the one or more second portions of the map, and at least one mutex of the one or more first mutexes is included in the one or more second mutexes.

D. The method of claim 1, wherein the one or more first geometric identifiers comprise one or more geometric descriptions that corresponds to one or more geographic regions of the environment projected to the one or more first portions of the map.

E. The method of claim 1, wherein the determining that the one or more first geometric identifiers correspond to the one or more second geometric identifiers comprises determining that at least one of the one or more second portions of the map overlap the one or more first portions of the map.

F. The method of claim 1, wherein the obtaining of the one or more first locks comprises causing, based at least on a first request received from the first client, the one or more first portions of the map to switch from being associated with a first state to being associated with a second state, the first state corresponding to an unlocked state and the second state corresponding to a locked state.

G. The method of claim 1, further comprising: establishing, based at least on the receiving of the one or more second requests to obtain the one or more second locks, the threshold period of time for the first client to unlock the one or more first locks, the threshold period of time being extendable based at least on activity of the first client; and releasing the one or more first locks based at least on a lapse of the threshold period of time.

H. The method of claim 1, further comprising sending an updated version of the map to one or more machines for use in operating in the environment, wherein the updated version of the map is generated based at least on the obtaining of the one or more first locks.

I. A system comprising: one or more processors to: obtain a first lock for a first client to apply one or more first updates to one or more first portions of a map of an environment;

associate, with the first lock, a priority and a geometric identifier corresponding to the one or more first portions of the map; and determine, based at least on the priority and the geometric identifier associated with the first lock, to refrain from obtaining, prior to releasing the first lock, one or more second locks for one or more second portions of the map that at least partially overlap the one or more first portions of the map.

J. The system of claim 9, the one or more processors further to: add, to a queue, data indicating one or more requests for the one or more second locks; and ordering, in the queue, the data indicating the one or more requests based at least on one or more of: one or more priorities associated with the one or more requests; an order in which the one or more requests were received; or one or more requested times for issuing the one or more second locks.

K. The system of claim 9, the one or more processors further to: release the first lock based at least on a second priority associated with at least one of the one or more second locks exceeding the priority associated with the first lock; and obtain the at least one of the one or more second locks subsequent to the release of the first lock.

L. The system of claim 9, the one or more processors further to: establish a timeout period for the first lock; determine that the timeout period has lapsed based at least on monitoring activity associated with the first lock; and responsive to the determination that the timeout period has lapsed: release the first lock; and revert a state associated with the one or more first portions of the map to a previous state.

M. The system of claim 9, the one or more processors further to: release the first lock based at least on the first client unlocking the first lock; and sending, to one or more machines, an updated version of the map of the environment, wherein the one or more machines use the updated version of the map to traverse one or more regions of the environment corresponding to the one or more first portions of the map.

N. The system of claim 9, wherein the geometric identifier is a geometric description that corresponds to one or more geographic regions of the environment projected to the one or more first portions of the map.

O. The system of claim 9, wherein: the first lock comprises one or more first mutual exclusions (mutexes) corresponding to the one or more first portions of the map, the one or more second locks comprises one or more second mutexes corresponding to the one or more second portions of the map, and at least one mutex of the one or more first mutexes is included in the one or more second mutexes.

P. The system of claim 9, the one or more processors further to: obtain, from one or more second clients, data indicating one or more requests for the one or more second locks and one or more second geometric identifiers corresponding to the one or more second portions of the map, wherein the determination to refrain from obtaining the one or more second locks is further based at least on an evaluation of the one or more second geometric identifiers with respect to the geometric identifier associated with the first lock.

Q. The system of claim 9, the one or more processors further to: add, to a queue, data indicating at least one of the one or more second locks requested by a second client; release the first lock; and obtain the at least one of the one or more second locks subsequent to the release of the first lock based at least on the addition of the data to the queue.

R. The system of claim 9, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

S. At least one processor comprising: processing circuitry to perform one or more operations associated with a machine using a map of an environment, wherein one or more concurrent updates are applied to the map, at least, by obtaining one or more first locks for updating one or more first portions of the map based at least on one or more geometric descriptions included in a request for the one or more first locks, and determining, based at least on the one or more geometric descriptions, to refrain from obtaining one or more second locks for one or more second portions of the map prior to releasing the one or more first locks.

T. The processor of claim 19, wherein the processor is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
obtaining one or more first locks for a first client to apply one or more first updates to one or more first portions of a map of an environment;
associating, with the one or more first locks, one or more first geometric identifiers indicative of the one or more first portions of the map;
receiving, prior to releasing the one or more first locks, one or more second requests to obtain one or more second locks for one or more second clients to apply one or more second updates to one or more second portions of the map, the one or more second requests including one or more second geometric identifiers;
determining that the one or more first geometric identifiers correspond to the one or more second geometric identifiers;
determining whether a threshold period of time has elapsed since the obtaining of the one or more first locks for the first client; and
determining, based at least on the one or more first geometric identifiers corresponding to the one or more second geometric identifiers and whether the threshold period of time has elapsed, whether to refrain from obtaining the one or more second locks for the one or more second clients.

2. The method of claim 1, further comprising:
receiving, prior to releasing the one or more first locks, one or more third requests to obtain one or more third locks for one or more third portions of the map that at least partially overlap the one or more first portions;
releasing the one or more first locks based at least on one or more lock priorities indicated in the one or more third requests; and
obtaining the one or more third locks for the one or more third portions of the map subsequent to the releasing.

3. The method of claim 1, wherein:
the one or more first locks comprise one or more first mutual exclusions (mutexes) corresponding to the one or more first portions of the map,
the one or more second locks comprise one or more second mutexes corresponding to the one or more second portions of the map, and
at least one mutex of the one or more first mutexes is included in the one or more second mutexes.

4. The method of claim 1, wherein the one or more first geometric identifiers comprise one or more geometric descriptions that corresponds to one or more geographic regions of the environment projected to the one or more first portions of the map.

5. The method of claim 1, wherein the determining that the one or more first geometric identifiers correspond to the one or more second geometric identifiers comprises determining that at least one of the one or more second portions of the map overlap the one or more first portions of the map.

6. The method of claim 1, wherein the obtaining of the one or more first locks comprises causing, based at least on a first request received from the first client, the one or more first portions of the map to switch from being associated with a first state to being associated with a second state, the first state corresponding to an unlocked state and the second state corresponding to a locked state.

7. The method of claim 1, further comprising:
establishing, based at least on the receiving of the one or more second requests to obtain the one or more second locks, the threshold period of time for the first client to unlock the one or more first locks, the threshold period of time being extendable based at least on activity of the first client; and
releasing the one or more first locks based at least on a lapse of the threshold period of time.

8. The method of claim 1, further comprising sending an updated version of the map to one or more machines for use in operating in the environment, wherein the updated version of the map is generated based at least on the obtaining of the one or more first locks.

9. A system comprising:
one or more processors to:
obtain a first lock for a first client to apply one or more first updates to one or more first portions of a map of an environment;
associate, with the first lock, a priority and a geometric identifier corresponding to the one or more first portions of the map; and
determine, based at least on the priority and the geometric identifier associated with the first lock, to refrain from obtaining, prior to releasing the first lock, one or more second locks for one or more second portions of the map that at least partially overlap the one or more first portions of the map.

10. The system of claim 9, the one or more processors further to:
add, to a queue, data indicating one or more requests for the one or more second locks; and
ordering, in the queue, the data indicating the one or more requests based at least on one or more of:
one or more priorities associated with the one or more requests;
an order in which the one or more requests were received; or
one or more requested times for issuing the one or more second locks.

11. The system of claim 9, the one or more processors further to:
release the first lock based at least on a second priority associated with at least one of the one or more second locks exceeding the priority associated with the first lock; and
obtain the at least one of the one or more second locks subsequent to the release of the first lock.

12. The system of claim 9, the one or more processors further to:
establish a timeout period for the first lock;
determine that the timeout period has lapsed based at least on monitoring activity associated with the first lock; and
responsive to the determination that the timeout period has lapsed:
release the first lock; and
revert a state associated with the one or more first portions of the map to a previous state.

13. The system of claim 9, the one or more processors further to:
release the first lock based at least on the first client unlocking the first lock; and
sending, to one or more machines, an updated version of the map of the environment, wherein the one or more machines use the updated version of the map to traverse one or more regions of the environment corresponding to the one or more first portions of the map.

14. The system of claim 9, wherein the geometric identifier is a geometric description that corresponds to one or more geographic regions of the environment projected to the one or more first portions of the map.

15. The system of claim 9, wherein:
the first lock comprises one or more first mutual exclusions (mutexes) corresponding to the one or more first portions of the map,
the one or more second locks comprises one or more second mutexes corresponding to the one or more second portions of the map, and
at least one mutex of the one or more first mutexes is included in the one or more second mutexes.

16. The system of claim 9, the one or more processors further to:
obtain, from one or more second clients, data indicating one or more requests for the one or more second locks and one or more second geometric identifiers corresponding to the one or more second portions of the map,
wherein the determination to refrain from obtaining the one or more second locks is further based at least on an evaluation of the one or more second geometric identifiers with respect to the geometric identifier associated with the first lock.

17. The system of claim 9, the one or more processors further to:
add, to a queue, data indicating at least one of the one or more second locks requested by a second client;
release the first lock; and
obtain the at least one of the one or more second locks subsequent to the release of the first lock based at least on the addition of the data to the queue.

18. The system of claim 9, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

19. At least one processor comprising:
processing circuitry to perform one or more operations associated with a machine using a map of an environment, wherein one or more concurrent updates are applied to the map, at least, by obtaining one or more first locks for updating one or more first portions of the map based at least on one or more geometric descriptions included in a request for the one or more first locks, and determining, based at least on the one or more geometric descriptions, to refrain from obtaining one or more second locks for one or more second portions of the map prior to releasing the one or more first locks.

20. The processor of claim 19, wherein the processor is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
